(19) United States
(12) Patent Application Publication
(10) Pub. No.: US 2017/0204267 A1
(43) Pub. Date: Jul. 20, 2017

(54) RECOVERED ASPHALT BINDER AND METHODS

(71) Applicant: Green Source Holdings LLC, Austin, TX (US)

(72) Inventors: Anthony Tyler FERGUSON, Austin, TX (US); Shahram Reza SHAFIE, Austin, TX (US)

(73) Assignee: Green Source Holdings LLC, Austin, TX (US)

(21) Appl. No.: 15/408,986

(22) Filed: Jan. 18, 2017

Related U.S. Application Data
(60) Provisional application No. 62/280,234, filed on Jan. 19, 2016.

(51) Int. Cl. C08L 95/00

(52) U.S. Cl. CPC C08L 95/00; C08L 2207/22

(57) ABSTRACT

A recovered asphalt binder with improved solubility and characteristics for use as filler to extend grade of base/virgin asphalt and related methods are described. A recovered asphalt binder with improved solubility, stiffening or softening, and performance-enhancing characteristics for use as modifier to upgrade base/virgin asphalt and related methods are described. Recovered asphalt binder with improved solubility, stiffening or softening, performance-enhancing and elastic characteristics for use as modifier to upgrade base/virgin asphalt and/or reduce polymer requirements and related methods are described. A recovered asphalt binder intermediately blended with one or more additives for use as filler to extend grade of base/virgin asphalt and related methods are described. Modified asphalt products made using a recovered asphalt binder and related methods are described.

### FIELD OF THE INVENTION

The present disclosure relates generally to a recovered asphalt binder and processes for manufacturing the recovered asphalt binder and modified asphalt binder products made using the recovered asphalt binder.

### BACKGROUND OF THE INVENTION

The recycling of used or discarded asphalt-containing materials, including but not limited to pavement and roofing products has gained interest as the price of petroleum-derived asphalt has increased. Asphalt is a black or dark brown viscous liquid or semi-solid material that consists of bitumen (i.e., hydrocarbons), oxygen, nitrogen, sulfur and other trace minerals. It can be classified according to four classes of compounds including asphaltenes, saturates, naphthene aromatics and polar aromatics.

Asphalt can be obtained from either naturally occurring sources, e.g., Trinidad lake asphalt, rock asphalt, oil sands, or as a refined petroleum product. While natural asphalts were used extensively during the early 20th century, the majority of asphalt currently produced in the United States is petroleum derived.

The quantity and composition of petroleum-derived asphalt depends on the crude oil feedstock source that is used. The crude oil undergoes distillation to produce a vacuum residue that can be used as base asphalt material, which typically constitutes a fraction of asphalt used to make asphalt-containing materials, e.g., pavement, roofing products.

Reclaimed asphalt pavement (RAP) has been used to produce hot mix asphalt (HMA). Asphalt pavement is removed during resurfacing, rehabilitation and reconstruction of roads. It is subsequently ground and processed to become RAP, which can be repurposed to substitute a portion of virgin asphalt binder and aggregate during pavement construction.

Reclaimed asphalt shingles (RAS) have also gained interest as a replacement to virgin asphalt binder and aggregate used during the construction of pavement. Several uses for recycled shingles include hot mix asphalt, cold asphalt patch, road dust suppressor, temporary road material, aggregate road base, new shingles and fuel. Of these uses, HMA is the largest current market, which requires grinding of shingles to approximately one quarter-inch for use as RAS.

Recycled materials such as RAP and RAS are used to reduce the amount of raw material required to produce asphalt paving mixtures. The amount of recycled material utilized is currently determined as a function of asphalt binder replacement. Assuming an asphalt pavement containing 5% asphalt binder and 95% aggregate, the following table illustrates how binder is replaced using RAP and RAS.

TABLE 1

| | Recycle | | | | | | | |
|---|---|---|---|---|---|---|---|---|
| | Material | | | | | | | |
| | Binder | Recycle | Recycle | New | Total | Recycle | New | Total |
| | Content | Total | Binder | Binder | Binder | Aggregate | Aggregate | Aggregate |
| Recycle | units | | | | | | | |
| Material | wt % | wt % | wt % | wt % | wt % | wt % | wt % | wt % |
| RAP | 5 | 20 | 1 | 4 | 5 | 19 | 76 | 95 |
| RAS | 20 | 5 | 1 | 4 | 5 | 4 | 91 | 95 |

Calculations
Recycle Binder = (Recycle Material Binder Content/100) × Recycle Total
New Binder = Total Binder − Recycle Binder
Recycle Aggregate = Recycle Material − Recycle Binder
New Aggregate = Total Aggregate − Recycle Aggregate

Table 1 shows that 20% RAP and 5% RAS both theoretically replace 1% asphalt binder. However, it is impractical to reactivate all binder present in the recycle material for the following reasons:

a. Particle size constraints limit the recycle surface area causing a significant fraction of binder to be encapsulated within the recycled aggregate structure;

b. Inefficient mixing of materials; and

c. Insufficient temperature to dissolve hardened recycle binder into virgin binder, i.e., recycle binder flows as liquid at temperature that exceeds about 100-180° C. when virgin binder has undergone oxidation.

In addition to containing hardened binders as a result of oxidation and volatilization of lighter organic compounds, the composition and state of recycled materials will vary based on climate, average daily temperatures and other geographical conditions. For this reason, it is common to assume only a fraction of binder contained in the recycled material is reactivated, e.g., 20-80%. Failure to follow this convention leads to dry asphalt mixtures, which often results in failure in the field, e.g., cracking.

Due to small particle sizing and the type of materials comprising asphalt shingles, it can also be difficult to uniformly blend RAS with liquid asphalt and aggregate during HMA production. To mitigate the risks of using RAS, many pavers limit the quantity used in HMA and/or assume reduced binder activation. Despite this effort, problems continue to ensue in pavements produced with RAS, which has caused many locales to altogether prohibit RAS use. The National Asphalt Pavement Association (NAPA) reported 2014 RAS usage in asphalt mixtures at 1.96 Million tons.

In 2014, approximately 140 Million squares (20.9 Million tons) of asphalt roofing shingles were manufactured. Of these, approximately one percent or two Million squares (0.2 Million tons) were allocated to new housing starts while the remaining 138 Million squares (20.7 Million tons) were used to replace shingles of existing houses, i.e., the quantity of newly manufactured shingles used to reroof existing houses is equal to the quantity of waste tear-off shingles generated annually. Factory scrap, including tab cut-outs and rejects, produced during the manufacturing process is another source of waste that typically constitutes 10% of total asphalt shingles manufactured and sold in a given year, e.g., approximately 14 Million squares (2.07 Million tons) in 2014. This equates to a total of approximately 152 Million squares (23 Million tons) of waste asphalt shingles generated from post-consumer shingles and factory scrap during 2014.

Of the 23 million tons of post-consumer and manufacturing scrap shingles generated annually, only 1.96 million tons or approximately 8.5% are used for paving applications. While a small portion of the remaining waste shingles may be used for purposes stated previously, it is estimated that 85-90% are landfilled. Annual disposal of approximately 20 Million tons of asphalt shingles is uneconomical from a waste management perspective and at the same time destroys valuable commodities. There is no effective method to recover the individual, clean asphalt shingle components in an economical and environmentally safe manner.

Historically, researchers employed solvent extraction to both quantify and characterize asphalt present in asphalt-containing materials. The most commonly used solvents to perform these tests have been 1,1,1-trichloroethane and trichloroethylene (TCE). Although the use of chlorinated solvents has been largely discontinued for environmental reasons (e.g., ozone depleting with significant release to atmosphere during solvent production, solvent-contaminated soil remediation difficulty), TCE continues to be used according to ASTM D 2042 in the laboratory environment to dissolve asphalt and subsequently determine asphalt content in asphalt-containing materials. Toluene is used according to ASTM D 5546 also to dissolve asphalt and subsequently determine asphalt content in asphalt-containing materials and according to ASTM D 7906 to determine asphalt characteristics in asphalt paving mixtures. The use of additional solvents, e.g., normal propyl bromide (nPB), has also been investigated as an alternative to perform asphalt extraction. Implementation of asphalt extraction technology using TCE, toluene, nPB and many other solvents produce overly stiffened, brittle recovered asphalt binder that adversely impacts the performance and durability of the recovered asphalt binder as well as asphalt binders blended with the recovered asphalt binder when used to make asphalt-containing products, e.g., pavement, roofing shingles. Moreover, these solvents are classified as either reasonably anticipated or known human carcinogens, which pose obvious environmental and health concerns.

Resistance to changes in properties such as penetration, elasticity, ductility and softening point with changes in temperature is a desirable characteristic of asphaltic materials. It is desirable that such asphaltic materials not become excessively hard, brittle or soft. Costs for asphaltic materials have increased significantly due to rising raw material costs. Attempts to recycle post-consumer asphaltic materials prior to the invention of the present disclosure have been problematic, often involving the use of potentially carcinogenic and environmentally harmful solvents, and producing products having low performance characteristics and/or that require expensive modifiers.

### SUMMARY OF INVENTION

An aspect of the present disclosure provides a recovered asphalt binder that is recovered from asphalt-containing materials, e.g., pavement, roofing products, rock asphalt, and/or oil sands. Another aspect of the invention provides a process for safely, economically and consistently making a recovered asphalt binder.

Another aspect of the present disclosure provides a recovered asphalt binder having excellent solubility and very low particulate matter content. Another aspect of the present disclosure provides a recovered asphalt binder useful for stiffening softer liquid asphalt products. Another aspect of the present disclosure provides a recovered asphalt binder having properties suitable to upgrade softer liquid asphalt products. Another aspect of the invention provides a process for safely, economically and predictably making a recovered asphalt binder as a precursor having properties suitable to modify base or virgin asphalt binder to produce modified asphalt binder products with improved performance grade. This precursor material may be referred to as a “recovered asphalt binder” herein. Liquid asphalt blends containing the recovered asphalt binder and other asphaltic material may be referred to as “modified asphalt binders” and “modified asphalt binder products” herein.

In another aspect, the present disclosure provides a recovered asphalt binder having improved stiffness and upgraded performance capabilities.

In another aspect, the present disclosure provides a recovered asphalt binder as a precursor having properties suitable for use as a modifier to improve both high temperature grade and low temperature grade of a given asphalt binder.

In another aspect, the present disclosure provides a recovered asphalt binder as a precursor having properties suitable for use as a modifier to improve high temperature grade with little to no degradation in low temperature grade of a given asphalt binder.

In another aspect, the present disclosure provides a recovered asphalt binder with improved elastic properties. In one aspect, the present disclosure provides a recovered asphalt binder with elastomeric properties similar to that of a polymer modified asphalt binder used to make high performance asphalt-containing materials, e.g., pavement, roofing products.

In another aspect, the present disclosure provides a recovered asphalt binder for intermediate blending with softer materials, to either directly meet desired liquid asphalt grades and/or characteristics, or as a precursor for use as a filler to extend a given asphalt binder grade. Softer materials may include, but are not limited to AC-2.5, AC-5, roofing flux, gas oil, lube oil, process oil, rejuvenating oil, recycling agents, bio-based oil and viscosity reducing agents.

The recovered asphalt binder of the present disclosure has advantages including more desirable properties, improved performance, significantly reduced costs associated with liquid asphalt modifier products used to upgrade conventional asphalt binders, and provides an environmentally friendly solution to landfill waste and pollution.

According to one aspect, the present disclosure provides a process involving a series of steps for treating asphalt-containing materials to obtain asphalt binder therefrom and to produce asphalt-free solids, which can optionally be separated further according to particle size. Major process steps include asphalt dissolution, solid-liquid separation, liquid-solid separation, drying, distillation and optionally solid-solid separation. Using the process described herein, a large array of modified asphalt binder products can be made using the recovered asphalt binder as a precursor in conjunction with other liquid asphalt products.

Still other aspects and advantages of the present invention will become readily apparent by those skilled in the art from the following detailed description, wherein it is shown and described preferred embodiments of the invention, simply by way of illustration of the best mode contemplated of carrying out the invention. As will be realized, the invention is capable of other and different embodiments, and its several details are capable of modifications in various obvious respects, without departing from the invention. Accordingly, the description is to be regarded as illustrative in nature and not as restrictive.

### BRIEF DESCRIPTION OF THE DRAWINGS

FIG. 1 is a block flow diagram of a process according to an embodiment of the present disclosure.

FIG. 2 is a block flow diagram of a process according to an embodiment of the present disclosure.

FIG. 3 is a block flow diagram of a process according to an embodiment of the present disclosure.

FIG. 4 is a graph showing elastic recovery increase versus recovered asphalt binder loading for modified asphalt binders.

FIG. 5 is a graph showing polymer loading versus recovered asphalt binder loading for modified asphalt binders.

FIG. 6 is a graph showing rubber loading versus recovered asphalt binder loading for modified asphalt binders.

FIG. 7 is a graph showing rubber loading versus recovered asphalt binder loading for modified asphalt binders.

### DETAILED DESCRIPTION OF INVENTION

As used herein, the terms “liquid asphalt,” “asphalt liquid,” “asphalt cement,” “asphalt binder” and “binder” refer to a black or dark brown liquid that consists of bitumen and inert mineral matter that is obtained from natural sources or is petroleum derived.

As used herein, the term “asphalt-containing materials” refers to any material, whether it be naturally occurring or man-made, that contains liquid asphalt or contained liquid asphalt at the time of manufacture or natural formation.

As used herein, the term “recovered asphalt binder” refers to a material that is recovered by a process of the present disclosure from asphalt-containing materials including, but not limited to, pavement, roofing shingles, rock asphalt and oil sands.

As used herein, the term “recycled asphalt binder” refers to liquid asphalt that is obtained from man-made asphalt-containing materials including, but not limited to, pavement and roofing shingles.

As used herein, the term “base asphalt binder” refers to liquid asphalt with properties determined by the crude oil source from which they are obtained during petroleum distillation, which may or may not include the use of modifiers and/or additives as part of the manufacturing process.

As used herein, the term “virgin asphalt binder” refers to liquid asphalt that has not been altered or modified with any additional materials.

As used herein, the term “blended asphalt binder” refers to a mixture of bituminous materials, including but not limited to, bitumen, liquid asphalt, asphalt binder, base asphalt binder and/or virgin asphalt binder.

As used herein, the term “modified asphalt binder” refers to liquid asphalt, blended or otherwise, that is subsequently altered with additional ingredients to either extend or modify the original asphalt.

As used herein, the terms “modifier” and “asphalt modifier” refer to materials used to improve liquid asphalt grade.

As used herein, the terms “additive” and “asphalt additive” refer to materials used as a filler to extend a liquid asphalt grade or to alter specific liquid asphalt properties.

As used herein, the terms “extender” and “asphalt extender” refer to an additive or additives used for altering liquid asphalt but preserving the original grade of the liquid asphalt.

As used herein, the term “elastic” refers to physical properties of a material that easily returns to its original size or shape after being stretched or otherwise deformed.

As used herein, the term “elastomer” refers to materials having elastic properties.

As used herein, the term “elasticity” refers to the degree that elastic properties are exhibited in a material.

As used herein, the term “softening” and “softening agent” describe a material, whether it be an additive or otherwise, used to soften and/or decrease the high temperature grade of liquid asphalt, increase penetration, increase softening point or decrease viscosity.

As used herein, the terms “stiffening” and “stiffening agent” describe a material, whether it be a modifier or otherwise, to harden and/or increase the high temperature grade of liquid asphalt, decrease penetration, decrease softening point or increase viscosity.

As used herein, the term “upgrade,” as applied to liquid asphalt, refers to improving the low temperature grade and/or high temperature grade as well as other asphalt binder properties.

As used herein, the terms “particulate matter” and “particulate solids” refer to solids and/or fines suspended in asphalt binder with a particle size between about 0.1-250 microns, e.g., 0.1, 0.2, 0.3, 0.4, 0.5, 0.75, 1, 2, 3, 4, 5, 10, 15, 20, 25, 30, 35, 45, 55, 65, 75, 90, 105, 125, 150, 175, 210 or 250 microns.

As used herein, the terms “asphalt mix,” “mix asphalt,” “hot mix asphalt” (HMA), “pavement” and “asphalt pavement” refer to a mixture of bituminous material and crushed stone, mineral filler or sand, i.e., aggregate.

As used herein, the term “reclaimed asphalt pavement” (RAP) refers to pavement that is removed during resurfacing, rehabilitation and reconstruction of roads.

As used herein, the terms “asphalt roofing shingles,” “asphalt roofing products,” “asphalt shingles,” “roofing shingles” and “shingles” refer to manufactured roofing products containing any combination of the following: liquid asphalt, cellulose or fiberglass reinforcing mat, mineral granules, aggregate, filler and stabilizer, polymer, as well as modified liquid asphalt adhesives.

As used herein, the term “reclaimed asphalt shingles” (RAS) refers to post-consumer and/or manufactured factory scrap shingles that are ground to about one-quarter inch to one-half inch in width and/or length and repurposed for commercial use.

As used herein, the terms “rock asphalt” and “limestone rock asphalt” refer to rock formations that are naturally impregnated with bituminous material.

As used herein, the terms “oil sands” and “tar sands” refer to naturally occurring formations comprised mainly of sand, clay, dirt, rock, minerals and bituminous material.

### Recovered Asphalt Binder

In one aspect, the invention includes a recovered asphalt binder. In certain embodiments, a recovered asphalt binder is produced having characteristics that make it useful as filler to extend the grade of a given liquid asphalt. In other embodiments, a recovered asphalt binder is produced having characteristics that make it useful as a modifier to stiffen or soften a given liquid asphalt. In other embodiments, a recovered asphalt binder is produced having characteristics that make it useful as a modifier to upgrade a given liquid asphalt. In other embodiments, a recovered asphalt binder is produced having characteristics that make it useful as a stiffening agent or softening agent having performance-enhancing and elastic characteristics for use as a modifier to upgrade a given liquid asphalt and/or to reduce the need for addition of polymer to liquid asphalt. In other embodiments, a recovered asphalt binder is produced having characteristics that make it useful for blending with one or more additives, to either directly meet desired liquid asphalt grades and/or characteristics, or for use as a filler to extend the grade of a given liquid asphalt. In other embodiments, a recovered asphalt binder is produced having characteristics that make it useful for making final asphalt products. In some embodiments, a recovered asphalt binder is produced having characteristics that make it useful for making roofing shingles. In some embodiments, a recovered asphalt binder is produced having characteristics that make it useful for making asphalt pavement.

In some embodiments, the recovered asphalt binder has less than about 1 wt. % (e.g., less than about 0.9%, about 0.7%, about 0.5%, 0.3%, 0.2%, 0.1% or close to 0 wt.%) particulate solids.

In some embodiments, solubility of the recovered asphalt binder in trichloroethylene according to ASTM D 2042 is greater than about 99%, e.g., greater than about 99.1%, about 99.3%, about 99.5%, 99.7%, 99.8%, 99.9% or close to 100%.

Paving asphalt binders can be classified into penetration grades according to ASTM D 946, which includes determination of penetration values according to ASTM D 5. The penetration of bituminous materials can also be determined according to AASHTO T 49. Penetration values have a unit of measure of 1/10 millimeters (mm) or decimillimeters (dmm). In terms of petroleum-refined asphalt, the softest penetration-graded liquid asphalt typically has a penetration value of 200-300 1/10 mm and the hardest penetration-graded liquid asphalt typically has a penetration value of 40-50 1/10 mm.

Roofing asphalt binders are classified as Types I-IV according to ASTM D 312, which includes determination of penetration values according to ASTM D 5. Penetration range requirements for roofing asphalt binder Types I, II, III and IV are defined by ASTM D 312 as 3-180, 6-100, 6-90 and 6-75 1/10 mm, respectively.

In certain embodiments, the recovered asphalt binder of the present disclosure has penetration values of between about 0 to 300 1/10 mm, e.g., 0, 1, 2, 3, 4, 5, 6, 7, 8, 9, 10, 20, 30, 40, 50, 75, 100, 150, 200, 250 or 300 1/10 mm.

ASTM D 312 classification of Types I-IV roofing asphalt binders also includes determination of softening point according to ASTM D 36. Softening point range requirements for roofing asphalt binder Types I, II, III, IV are defined by ASTM D 312 as 57-66, 70-80, 85-96 and 99-107° C., respectively. In certain embodiments, the recovered asphalt binder of the present disclosure has softening points of about 20 to 200° C., e.g., 20, 30, 40, 50, 60, 70, 80, 90, 100, 110, 120, 130, 140, 150, 160, 170, 180, 190 or 200° C.

The Performance Graded (PG) Asphalt Binder Specification, which consists of a high temperature grade requirement and a low temperature grade requirement for asphalt binders, was developed to measure the rutting and cracking of an asphalt binder at temperatures relevant to the in-service climate where the corresponding HMA is intended for use. That is, the tests performed and the specification limits of what constitutes an acceptable asphalt binder do not change, but each test is performed at a temperature according to regional climate requirements. For example, a PG 64-22 asphalt binder has a high temperature grade of 64° C. and a low temperature grade of −22° C.

As used herein, “PG” stands for Performance Graded, which is based on the idea that the properties of an asphalt binder used to construct pavement should be related to the climatic conditions under which it is used. The PG system uses a common battery of tests as indicated by AASHTO M 320 that specify that a particular asphalt binder must pass such tests at specific temperatures that are based upon the specific climate conditions in the area of use.

PG asphalt binders do not account for traffic loading, hence the practice of grade bumping as referred to in the asphalt paving industry. As used herein, the term “grade bumping” refers to the practice of using additives and/or modifiers to improve the temperature performance of a PG asphalt binder. In practice, grade bumping or “improving the PG” as used herein includes temperature improvements by increasing the high temperature grade of a PG asphalt binder, decreasing the low temperature grade of a PG asphalt binder, or both increasing the high temperature grade of a PG asphalt binder and decreasing the low temperature grade of a PG asphalt binder.

In the U.S., all states currently utilize the PG Asphalt Binder Specification to grade asphalt binder whereas modifiers used to perform grade bumping are defined at state level and are typically referred to as a “PG Plus” specification. PG Plus specifications define modifiers approved for use, or can place no restriction on modifier type, and typically provide a measure based on target modified PG asphalt binder grade to determine if adequate modifier has been added to the original PG asphalt binder. The most common measure to determine if a satisfactory amount of modifier has been used is elastic recovery by ASTM D 6084. PG Plus specifications typically define a minimum elastic recovery requirement based on modified PG asphalt binder grade. In this regard, minimum elastic recovery requirements are established to ensure that PG asphalt binders for use in high performance applications have sufficient elastic properties to compensate for high volume and/or slow moving traffic conditions in order to avoid pavement rutting, i.e., permanent deformation. Another more recently developed measure to determine if a suitable quantity of modifier has been used to produce modified asphalt binders is the multiple stress creep recovery (MSCR) test according to AASHTO T 350.

Table 2 shows PG asphalt binder grades used on a national level according to regional pavement climate requirements.

Striped cells include PG asphalt binders that can be sourced from crude oil directly, i.e., the crude source produces liquid asphalt that meets the base binder specification based on temperature requirements for a given climate. Gray cells include PG asphalt binders that can only be achieved via modification to a petroleum-derived base asphalt binder. White cells include PG asphalt binders that can be sourced in limited quantities from high quality crude oil; therefore, modification is very often required to produce substantial quantities of these PG asphalt binders. The useful temperature interval (UTI) is defined as the difference between the high temperature grade and the low temperature grade, or temperature spread, of a PG asphalt binder. For example, PG 64-22 has a UTI of 86; PG 70-22 has a UTI of 92; and PG 76-22 has a UTI of 98. The general rule of thumb is that if UTI: (1) is greater than 92, binder is modified; (2) is 92, binder is most likely modified; and (3) is less than 92, binder is probably not modified.

PG asphalt binders have a typical high temperature grade range from 52° C. to 76° C. The high temperature grade is measured using a 25 millimeter (mm) dynamic shear rheometer (DSR) according to AASHTO T 315. PG binders also have a typical low temperature grade range from −10° C. to −40° C. The low temperature grade is measured using a bending beam rheometer (BBR) according to AASHTO T 313. The low temperature grade can alternatively be measured using a 4 mm DSR according to a method development by Western Research Institute.

In certain embodiments, recovered asphalt binder has a high temperature grade of about 30° C. to 200° C., e.g., 30, 40, 50, 60, 70, 80, 90, 100, 110, 120, 130, 140, 145, 150, 155, 160, 165, 170, 175, 180, 185, 190, 191, 192, 193, 194, 195, 196, 197, 198, 199, or 200° C. In certain embodiments, recovered asphalt binder has a low temperature stiffness grade, i.e., temperature associated with s-value, of about 20° C. to −60° C., e.g., 20, 15, 10, 5, 0, −5, −10, −15, −20, −25, −30, −35, −40, −45, −50, −55 or −60° C. and low temperature m-value grade, i.e., temperature associated with slope of s-value, of about 20° C. to −60° C., e.g., 20, 15, 10, 5, 0, −5, −10, −15, −20, −25, −30, −35, −40, −45, −50, −55 or −60° C.

In certain embodiments, the invention is directed to a precursor material that consists essentially of recovered asphalt binder. As used herein, the term “consists essentially of” means that the precursor material contains less than 1% solvent, e.g., 0, 0.001, 0.01, 0.1, 0.2, 0.3, 0.4, 0.5, 0.6, 0.7, 0.8, 0.9 or 0.95% solvent, and less than 1% particulate matter, 0.05, 0.1, 0.2, 0.3, 0.4, 0.5, 0.6, 0.7, 0.8, 0.9 or 0.95% particulate matter.

In another aspect, the invention includes a method for making a recovered asphalt binder. A process according to the invention may be carried out by immersing asphalt-containing materials in one or more asphalt-dissolving liquids. In certain aspects, the method includes contacting an asphalt-containing material with an asphalt-dissolving liquid in a reaction mixture at about 30° C. to about 100° C. for about 1 to about 100 minutes, e.g., 1, 5, 10, 15, 20, 25, 30, 35, 40, 45, 50, 55, 60, 65, 70, 75, 80, 85, 90, 95, or 100 minutes. In certain aspects, the contacting occurs at a temperature of about 40° C. to about 90° C. for about 20 to about 80 minutes. In certain aspects, the contacting occurs at a temperature of about 60° C. to about 80° C. for about 20 to about 60 minutes. In certain aspects, the contacting occurs at a temperature of about 70° C. to about 75° C.

In one embodiment, the asphalt-containing material is pavement, which is processed to recover liquid asphalt therefrom and produce asphalt-free solids that can be further separated into aggregate according to particle size. In another embodiment, the asphalt-containing material is post-consumer and/or factory scrap roofing shingles, which are processed to recover liquid asphalt therefrom and produce asphalt-free solids that can be further separated into fiberglass, fine aggregate and mineral filler according to particle size. In another embodiment, the asphalt-containing material is rock asphalt, which is processed to recover liquid asphalt therefrom and produce asphalt free-solids that can be further separated into aggregate according to particle size. In another embodiment, the asphalt-containing material is oil sands, which are processed to recover bitumen therefrom and produce asphalt free solids containing clay and sand.

In certain embodiments, specific asphalt-dissolving fluids are used for solvent extraction including turpentine fluids alone or turpentine fluids in combination with non-turpentine aromatic fluids or paraffinic fluids. As used herein, non-turpentine aromatic fluids are non-turpentine fluids that contain aromatic components having a carbon number of C₅ to C₂₀, a boiling point range from about 100° C. to about 400° C. and a density of about 0.8 g/mL to about 1.0 g/mL at 15.6° C., e.g., aromatic fluid 100 (CAS #64742-95-6), aromatic fluid 150 or 200 (CAS #64742-94-5). In certain embodiments, a non-turpentine aromatic fluid may have a boiling point of about 110° C. to about 340° C., about 110° C. to about 225° C., about 150° C. to about 225° C., or about 285° C. to about 400° C. In certain embodiments, a non-turpentine aromatic fluid may have a carbon number of C₆ to C₁₄ or C₈ to C₁₂. In one embodiment, asphalt-dissolving fluids contain only turpentine fluids as active ingredients and do not contain non-turpentine aromatic fluids. For example, in some embodiments, asphalt-dissolving fluids do not contain any non-turpentine aromatic components. As used herein, non-turpentine paraffinic fluids contain paraffinic components having a carbon number of C₅ to C₂₀, a boiling point range from about 50° C. to about 400° C. and a density of about 0.6 g/mL to about 0.9 g/mL at 15.6° C., e.g., 142 flash solvent (CAS #64742-47-8), Isopar E (CAS #64741-66-8), Isopar H (CAS #64742-48-9). In certain embodiments, a non-turpentine paraffinic fluid may have a boiling point of about 50° C. to about 400° C., about 110° C. to about 350° C., about 150° C. to about 225° C., or about 250° C. to about 400° C. In certain embodiments, a non-turpentine paraffinic fluid may have a carbon number of C₆ to C₁₀ or C₉ to C₁₂. In one embodiment, asphalt-dissolving fluids contain only turpentine fluids as active ingredients and do not contain non-turpentine paraffinic fluids. For example, in some embodiments, asphalt-dissolving fluids do not contain any non-turpentine paraffinic components.

In certain embodiments, the asphalt-dissolving fluid is non-aqueous or substantially non-aqueous. As used herein, the term substantially non-aqueous refers to a fluid that contains less than 1 wt. % water, e.g., less than 0.8, 0.7, 0.6, 0.5, 0.4, 0.3, 0.2, or 0.1 wt. % water.

In other embodiments, asphalt-dissolving fluids contain between 0.5% and 49.5% of a non-turpentine aromatic fluid, paraffinic fluid or combination thereof. In some embodiments, asphalt-dissolving fluids contain between 1% and 40% of a non-turpentine aromatic fluid, paraffinic fluid or combination thereof, e.g., 1, 5, 10, 15, 20, 25, 30, 35, or 40%. In other embodiments, asphalt-dissolving fluids contain between 10% and 20% of a non-turpentine aromatic fluid, paraffinic fluid or combination thereof.

The turpentine liquid is any one or more liquids selected from the group consisting of: natural turpentine, synthetic turpentine, pine oil, crude stump turpentine, crude wood oil, d-limonene, α-pinene, β-pinene, α-terpineol, β-terpineol, γ-terpineol, 3-carene, anethole, dipentene (p-mentha-1,8-diene), terpene resins, nopol, pinane, camphene, p-cymene, anisaldehyde, 2-pinane hydroperoxide, 3,7-dimethyl-1,6-octadiene, isobornyl acetate, terpin hydrate, ocimene, 2-pinanol, dihydromyrcenol, isoborneol, a-terpineol, alloocimene, alloocimene alcohols, geraniol, 2-methoxy-2,6-dimethyl-7,8-epoxyoctane, camphor, p-menthan-8-ol, α-terpinyl acetate, citral, citronellol, 7-methoxydihydrocitronellal, 10-camphorsulphonic acid, p-menthene, p-menthan-8-yl acetate, citronellal,7-hydroxydihydrocitronellal, menthol, menthone, polymers thereof, and mixtures thereof. In certain embodiments, the turpentine liquid excludes limonene.

According to a preferred aspect of the invention, the asphalt-dissolving liquid may contain turpentine liquid, e.g., any one or more liquids selected from the group consisting of α-pinene, β-pinene, α-terpineol, p-cymene, polymers thereof, and mixtures thereof.

The asphalt-dissolving liquid may contain one or more turpentine fluids, e.g., one or more fluids including α-terpineol, β-terpineol, α-pinene, β-pinene, and/or p-cymene. The turpentine fluids may contain 90-100% a-terpineol, α-pinene, β-pinene, or pine oil. In one embodiment, a multi-component turpentine fluid includes at least about 30%, 40% or 50% α-terpineol in combination with one or more of natural turpentine, synthetic turpentine, pine oil, crude stump turpentine, crude wood oil, d-limonene, α-pinene, β-pinene, α-terpineol, β-terpineol, γ-terpineol, 3-carene, anethole, dipentene (p-mentha-1,8-diene), terpene resins, nopol, pinane, camphene, p-cymene, anisaldehyde, 2-pinane hydroperoxide, 3,7-dimethyl-1,6-octadiene, isobornyl acetate, terpin hydrate, ocimene, 2-pinanol, dihydromyrcenol, isoborneol, α-terpineol, alloocimene, alloocimene alcohols, geraniol, 2-methoxy-2,6-dimethyl-7,8-epoxyoctane, camphor, p-menthan-8-ol, α-terpinyl acetate, citral, citronellol, 7-methoxydihydrocitronellal, 10-camphorsulphonic acid, p-menthene, p-menthan-8-yl acetate, citronellal,7-hydroxydihydrocitronellal, menthol, and menthone. For example, a multicomponent turpentine fluid may contain 30-70% α-terpineol, 5-40% β-pinene, 5-50% α-pinene, and 0-30% p-cymene; 40-60% α-terpineol, 10-20% α-pinene, 10-40% β-pinene, and 5-20% p-cymene; 45-55% α-terpineol, 30-40% α-pinene, 5-30% β-pinene, and 10-30% p-cymene; 50% α-terpineol, 25% α-pinene, 20% β-pinene, and 5% p-cymene; 30-70% pine oil, 30-70% α-terpineol, 5-40% β-pinene, 5-50% α-pinene, and 0-30% p-cymene; 15-25% α-terpineol, 10-15% α-pinene, 10-15% β-pinene, and 45-65% p-cymene; 10-20% α-terpineol, 5-10% α-pinene, 5-10% β-pinene, and 40-80% p-cymene; 5-35% α-terpineol, 5-15% α-pinene, 5-15% β-pinene, and 35-85% p-cymene; 30-50% pine oil, 40-60% α-terpineol, 10-20% α-pinene, 10-40% β-pinene, and 5-20% p-cymene; 30-40% pine oil, 45-55% α-terpineol, 30-40% α-pinene, 5-30% β-pinene, and 10-30% p-cymene.

In another embodiment, the blend of turpentine liquids includes about 30-70% α-terpineol, about 5-40% β-pinene, 5-50% α-pinene, and about 0-40% p-cymene. In another embodiment, the blend of turpentine liquids includes about 40-60% α-terpineol, about 10-20% α-pinene, about 10-40% β-pinene, and about 5-35% p-cymene. In an alternative embodiment, a blend of turpentine liquids includes about 45-55% α-terpineol, about 30-40% α-pinene, about 5-30% β-pinene, and about 10-30% p-cymene. In another embodiment, a blend of turpentine liquids includes about 50% α-terpineol, about 25% α-pinene, about 20% β-pinene, and about 5% p-cymene.

The turpentine liquids may be a blend including pine oil, α-terpineol, β-terpineol, α-pinene, β-pinene, and/or p-cymene. In one embodiment, the multi-component turpentine liquid includes at least about 30% pine oil. In another embodiment, the blend of turpentine liquids includes about 30-70% pine oil, about 30-70% a-terpineol, about 5-40% β-pinene, 5-50% α-pinene, and about 0-30% p-cymene. In another embodiment, the blend of turpentine liquids includes about 30-50% pine oil, about 40-60% α-terpineol, about 10-20% α-pinene, about 10-40% β-pinene, and about 5-20% p-cymene. In an alternative embodiment, a blend of turpentine liquids includes about 30-40% pine oil, about 45-55% a-terpineol, about 30-40% α-pinene, about 5-30% β-pinene, and about 10-30% p-cymene. In certain aspects, a reaction mixture includes one or more asphalt-dissolving liquids and an asphalt-containing material in a ratio of about 0.5:1 to about 20:1, about 2:1 to about 15:1, 3:1 to 10:1, 4:1 to 7:1, or 5:1. Unless otherwise noted herein, ratios are disclosed as weight ratios.

By utilizing any of the asphalt-dissolving liquids and processes of this invention, liquid asphalt can be recovered from asphalt-containing materials using a simple technique without the need for aromatic solvents, paraffinic solvents, environmentally deleterious solvents including, but not limited to toluene, TCE, and nPB, as well as processes requiring elevated temperatures, elevated pressures, shredding, complex machinery or steps, and/or expensive modifiers.

In certain embodiments, the method includes the step of providing an alcohol, an organic compound with a hydroxyl functional group, and/or one or more common solvents such as an organic or inorganic solvent, and contacting the asphalt-containing material, which has already been treated with an asphalt-dissolving fluid of the present disclosure, with the alcohol, or a mixture of the alcohol with an organic compound with one or more hydroxyl functional group(s) and/or an organic or inorganic solvent, such that a recovery mixture is formed, as well as residual material. The recovery mixture contains at least a portion of the turpentine liquid that was trapped within the asphalt-containing material and at least one of the alcohol, the organic compound with one or more hydroxyl functional group(s), and/or organic or inorganic solvent.

In one embodiment, at least one alcohol or organic compound with one or more hydroxyl functional group(s) is contacted with the post-treated asphalt-containing material in a ratio of about 0.5:1 to about 20:1, about 2:1 to about 15:1, 3:1 to 10:1, 4:1 to 7:1, or 5:1. Unless otherwise noted herein, ratios are disclosed as weight ratios.

In one embodiment, the alcohol is one or more acyclic or cyclic alcohols. For example, the alcohol can be simple alcohols such as methanol (methyl alcohol), ethanol (ethyl alcohol), propanol (propyl alcohol), isopropanol, butanol, isobutanol, pentanol and its eight more isomers (1-Pentanol, 3-Methyl-1-butanol, 2-Methyl-1-butanol, 2,2- Dimethyl- 1-propanol, 3-Pentanol, 2-Pentanol, 3-Methyl-2-butanol, 2-Methyl-2-butanol) and hexanol and its sixteen more isomers (1-Hexanol, 2-Hexanol, 3-Hexanol, 2-Methyl-1-pentanol, 3-Methyl-1-pentanol, 4-Methyl-1-pentanol, 2-Methyl-2-pentanol, 3-Methyl-2-pentanol, 4-Methyl-2-pentanol, 2-Methyl-3-pentanol, Tertiary 3 -Methyl-3-pentanol, Primary 2,2-Dimethyl-1-butanol, 2,3-Dimethyl-1-butanol, 3,3-Dimethyl-1-butanol, 2,3-Dimethyl-2-butanol, 3,3-Dimethyl-2-butanol, 2-Ethyl-1-butanol), lower aliphatic alcohols, or a mixture thereof. In certain embodiments, the alcohol is methanol (methyl alcohol), ethanol (ethyl alcohol), propanol (propyl alcohol), isopropanol, butanol, isobutanol, pentanol, hexanol, or a mixture thereof.

As used herein, the term “lower aliphatic alcohols” refers to primary, secondary and tertiary monohydric and polyhydric alcohols of between 2 and 12 carbon atoms. As used herein, the term “alkanes” refers to straight chain and branched chain alkanes of between 5 and 22 carbon atoms. As used herein, the term “aromatics” refers to monocyclic, heterocyclic and polycyclic compounds. As used herein, the term “paraffinics” refers to a saturated hydrocarbon, whether cyclic or acyclic. As used herein, the term “aliphatic amines” refers to primary, secondary and tertiary amines having alkyl substituents of between 1 and 15 carbon atoms.

In one embodiment, the present disclosure provides a process for providing an asphalt-dissolving liquid and contacting asphalt-containing materials with the asphalt-dissolving liquid to form a slurry extraction mixture. According to one embodiment, the contacting occurs while heating with or without agitation. According to the invention, liquid asphalt contained within the asphalt-containing materials is dissolved into the asphalt-dissolving liquid. The resulting extraction mixture is subjected to solid-liquid separation to remove a liquid containing asphalt-dissolving liquid, dissolved liquid asphalt and any particulate solids not separated from the post-extracted asphalt-containing material solids portion. In certain embodiments, the solids portion is subjected to one or more subsequent asphalt-dissolving and/or washing steps, thereby displacing residual liquid asphalt from the solids. In certain embodiments, the liquid portion is subjected to one or more liquid-solid separation steps to remove particulate solids from the liquid portion. In certain embodiments, post-extracted solids from the solid-liquid separation step are dried. In certain embodiments, post-extracted solids from the solid-liquid separation step and particulate solids from the liquid-solid separation step(s) are combined and dried. Asphalt-dissolving liquid evolved during drying is condensed according to the composition of the asphalt-dissolving liquid at a temperature between about 50 and 400° C., e.g., between about 60° C. and 160° C., between110° C. and 180° C., between 200° C. and 380° C., between 190° C. and 260° C., collected and optionally recycled to the contacting step.

In certain embodiments, solids obtained during drying can optionally be separated further according to particle size using solid-solid separation techniques. In certain embodiments, solid-solid separation is not required.

In certain embodiments, liquid obtained from either solid-liquid separation or subsequent liquid-solid separation steps to remove particulate solids from the liquid portion, which contains asphalt-dissolving liquid and dissolved liquid asphalt is subjected to distillation to separate and recycle asphalt-dissolving liquid to the process and to obtain recovered asphalt binder.

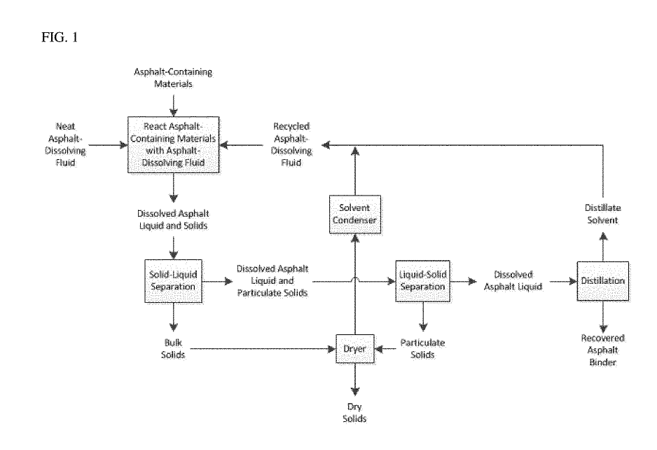

As shown in FIG. 1, a process involves contacting asphalt-containing materials with an asphalt-dissolving fluid to form a reaction mixture containing liquid asphalt dissolved into an asphalt-dissolving fluid and solids. A solid-liquid separation of the reaction mixture is performed to produce a portion of bulk solids and a liquid portion of liquid asphalt dissolved into an asphalt-dissolving fluid and particulate matter. The process further involves performing liquid-solid separation of the liquid portion to produce a particulate solids portion and a liquid portion of liquid asphalt dissolved into an asphalt-dissolving fluid, which has very low particulate matter content, e.g., less than 0.05, 0.1, 0.2, 0.3, 0.4, 0.5, 0.6, 0.7, 0.8, 0.9, 0.95 or 1% particulate matter. The virtually particulate-free liquid portion may be subjected to distillation to produce a distilled asphalt-dissolving fluid portion and a recovered asphalt binder portion. In certain embodiments, a process may involve conveying bulk solids and/or particulate solids to a dryer to obtain dried solids. In certain embodiments, asphalt-dissolving fluid evolved during drying of bulk solids and/or particulate solids may be condensed using an asphalt-dissolving fluid condenser to obtain recycled asphalt-dissolving fluid.

In certain embodiments, a dried solids portion is subjected to one or more solid-solid separation steps to classify remaining material according to particle size.

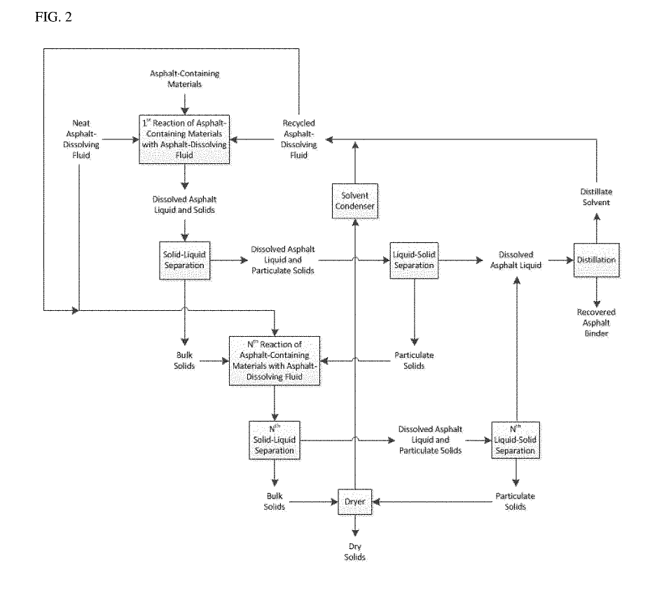

As shown in FIG. 2, a process involves contacting asphalt-containing materials with an asphalt-dissolving fluid to form a first reaction mixture containing liquid asphalt dissolved into an asphalt-dissolving fluid and solids. A solid-liquid separation of the first reaction mixture is performed to produce a portion of bulk solids and a liquid portion of liquid asphalt dissolved into an asphalt-dissolving fluid and particulate matter.

The process further involves performing liquid-solid separation of the liquid portion to produce a particulate solids portion and a liquid portion of liquid asphalt dissolved into an asphalt-dissolving fluid, which has very low particulate matter content, e.g., less than 0.05, 0.1, 0.2, 0.3, 0.4, 0.5, 0.6, 0.7, 0.8, 0.9, 0.95 or 1% particulate matter. The virtually particulate-free liquid portion may be subjected to distillation to produce a distilled asphalt-dissolving fluid portion and a recovered asphalt binder portion.

The process also involves one or more steps of contacting post-treated solids and/or particulate solids with an asphalt-dissolving fluid to form a N^{th} reaction mixture containing liquid asphalt dissolved into an asphalt-dissolving fluid and solids, wherein N is the number of contacting steps. A solid-liquid separation of the N^{th} reaction mixture is performed to produce a secondary portion of bulk solids and a secondary liquid portion of liquid asphalt dissolved into an asphalt-dissolving fluid and particulate matter. A liquid-solid separation of the secondary liquid portion is performed to produce a secondary particulate solids portion and a secondary liquid portion of liquid asphalt dissolved into an asphalt-dissolving fluid, which has very low particulate matter content, e.g., less than 0.05, 0.1, 0.2, 0.3, 0.4, 0.5, 0.6, 0.7, 0.8, 0.9, 0.95 or 1% particulate matter. The virtually particulate-free secondary liquid portion may be subjected to distillation to produce a distilled asphalt-dissolving fluid portion and a recovered asphalt binder portion. In certain embodiments, the process may involve conveying the second bulk solids and/or particulate solids to a dryer to obtain dried solids. In certain embodiments, asphalt-dissolving fluid evolved during drying of bulk solids and/or particulate solids may be condensed using an asphalt-dissolving fluid condenser to obtain recycled asphalt-dissolving fluid.

In certain embodiments, a dried solids portion is subjected to one or more solid-solid separation steps to classify remaining material according to particle size.

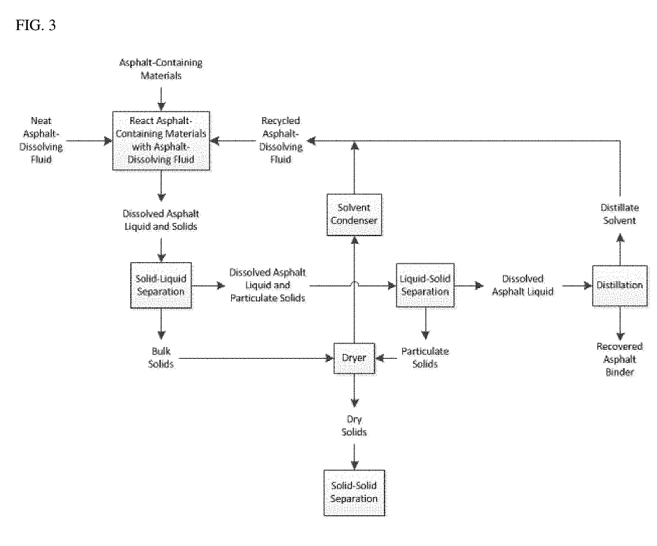

As shown in FIG. 3, a process involves contacting asphalt-containing materials with an asphalt-dissolving fluid to form a reaction mixture containing liquid asphalt dissolved into an asphalt-dissolving fluid and solids. A solid-liquid separation of the reaction mixture is performed to produce a portion of bulk solids and a liquid portion of liquid asphalt dissolved into an asphalt-dissolving fluid and particulate matter. The process further involves performing liquid-solid separation of the liquid portion to produce a particulate solids portion and a liquid portion of liquid asphalt dissolved into an asphalt-dissolving fluid, which has very low particulate matter content, e.g., less than 0.05, 0.1, 0.2, 0.3, 0.4, 0.5, 0.6, 0.7, 0.8, 0.9, 0.95 or 1% particulate matter. The virtually particulate-free liquid portion may be subjected to distillation to produce a distilled asphalt-dissolving fluid portion and a recovered asphalt binder portion. The bulk solids and/or particulate solids are conveyed to a dryer to obtain dried solids. Asphalt-dissolving fluid evolved during drying of bulk solids and/or particulate solids may be condensed using an asphalt-dissolving fluid condenser to obtain recycled asphalt-dissolving fluid. The dried solids portion is subjected to one or more solid-solid separation steps to classify remaining material according to particle size.

In certain embodiments, one or more processes according to the present disclosure are batch processes. As used herein, the term “batch process” may define a process in which one or more, or all of the process steps are discontinuous and performed using batches of materials. In certain embodiments, one or more processes according to the present disclosure are continuous processes. As used herein, the term “continuous process” may define a process in which a plurality or all of the process steps are continuously performed. Any of the processes of FIGS. 1-3 may be performed as batch processes, continuous processes, or partially continuous processes that include continuous operation of certain steps and batch processing of other components.

According to an aspect of the invention, asphalt-containing materials may be provided in any size that facilitates contact with the asphalt-dissolving fluid of the present disclosure. The asphalt-containing materials may be provided as whole pieces, comminuted pieces, or ground pieces. According to one aspect of the invention, the asphalt-containing materials are provided in sizes of about 0.00015 inch (35 μm) to 1 inch (25.4 mm) in width and/or length. In certain embodiments, the asphalt-containing materials are provided in sizes of about one-quarter inch to one-half inch in width and/or length. Size reduction may be effected by grinding, shredding, milling, comminuting or any other suitable process.

In one embodiment, a process according to the present disclosure may be carried out by immersing post-consumer and/or factory scrap roofing shingles in an asphalt-dissolving liquid in the form of whole shingles or comminuted shingles whose sizes are within the range of about one-eight inch to about one-half inch in a contacting vessel (reactor) that contains an asphalt-dissolving liquid.

According to an aspect of the invention, the asphalt-containing materials and the asphalt-dissolving liquid are contacted at a temperature of about 30° C. to about 100° C. In one embodiment, asphalt-containing materials are contacted at a temperature of from about 40° C. to about 90° C. In certain embodiments, asphalt-containing materials are contacted at a temperature of about 60° C. to 80° C., e.g., 60, 65, 70, 75 or 80° C.

According to an aspect of the invention, the asphalt-containing materials and the asphalt-dissolving liquid are contacted for a time of about 1 minute to about 100 minutes. In one embodiment, asphalt-containing materials are contacted for a time of about 10 minutes to about 80 minutes. In certain embodiments, asphalt-containing materials are contacted for a time of about 20 minutes to about 50 minutes, e.g., 20, 25, 30, 35, 40, 45 or 50 minutes.

According to an aspect of the invention, a slurry extraction mixture that contains asphalt-dissolving liquid, dissolved liquid asphalt and solids undergoes one or more solid-liquid separation steps to separate a liquid that contains asphalt-dissolved liquid, dissolved asphalt liquid and particulate solids from bulk solids. In certain embodiments, a slurry extraction mixture undergoes gravity settling to allow a portion of solids to settle prior to liquid decantation. In one embodiment, a slurry extraction mixture is subjected to filtration using filter media with nominal pore size from about 0.4 microns to about 50 microns. In one embodiment, a slurry extraction mixture is subjected to multi-stage filtration using filter media with ranges in nominal pore size from about 0.4 microns to about 25 microns, e.g., 0.4, 1, 2, 3, 4, 5, 8, 10, 15, 20 or 25 microns. In one embodiment, a slurry extraction mixture is subjected to centrifugation with a gravitational-force from about 300 to about 10,000 for a time of about 1 minute to about 30 minutes. In one embodiment, a slurry extraction mixture is subjected to centrifugation with a gravitational-force from about 3,000 to about 6,000 for a time of about 3 minutes to about 20 minutes. In one embodiment, a slurry extraction mixture is subjected to centrifugation with a gravitational-force from about 4,500 to about 9,000 for a time of about 2 minutes to about 10 minutes.

In certain embodiments, a liquid that contains asphalt-dissolving liquid, dissolved liquid asphalt and particulate solids undergoes one or more liquid-solid separation steps to remove particulate matter from the liquid portion. In one embodiment, a liquid that contains asphalt-dissolving liquid, dissolved liquid asphalt and particulate solids is subjected to filtration using filter media with nominal pore size from about 0.4 microns to about 10 microns, e.g., 0.4, 1, 2, 3, 4, 5, 6, 7, 8, 9 or 10 microns. In one embodiment, a liquid that contains asphalt-dissolving liquid, dissolved liquid asphalt and particulate solids is subjected to multi-stage filtration using filter media with ranges in nominal pore size from about 0.4 microns to about 5 microns, e.g., 0.4, 1, 2, 3, 4 or 5 microns. In one embodiment, a liquid that contains asphalt-dissolving liquid, dissolved liquid asphalt and particulate solids is subjected to centrifugation with a gravitational-force from about 300 to about 10,000 for a time of about 1 minute to about 30 minutes.

In certain embodiments, post-extracted solids obtained during solid-liquid separation and/or particulate matter from liquid-solid separation are subjected to one or more subsequent asphalt-dissolving and/or washing steps, thereby displacing residual liquid asphalt from the solids, prior to repeating any further solid-liquid separation and liquid-solid separation steps.

According to an aspect of the invention, post-treated solids obtained during solid-liquid separation and/or particulate matter from liquid-solid separation can contain residual asphalt-dissolving fluid in an amount ranging from about 1 wt % to about 30 wt %, e.g., 1, 5, 10, 15, 20, 25 or 30 wt %. In certain embodiments, post-treated solids obtained during solid-liquid separation and/or particulate matter from liquid-solid separation are dried using a drying unit at a temperature of about 50° C. to about 400° C., e.g., 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390 or 400° C.

In certain embodiments, asphalt-dissolved liquid evolved during drying of post-extracted solids obtained during solid-liquid separation and/or particulate matter from liquid-solid separation is condensed using a non-aqueous condenser at about 50° C. to about 400° C., e.g., 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390 or 400° C., collected and optionally recycled to the contacting step.

In certain embodiments, solids obtained during drying can optionally be separated further and classified according to particle size from about 5 μm to 2,000 μm (2 mm), e.g., 5, 10, 20, 30, 40, 50, 60, 80, 100, 120, 150, 200, 250, 500, 750, 1,000, 1,500 or 2,000 μm, using solid-solid separation techniques understood to those skilled in the art, e.g., screening, sifting. In certain embodiments, solid-solid separation is not required.

In certain embodiments, liquid obtained from either solid-liquid separation or subsequent liquid-solid separation to remove particulate solids from the liquid portion, which contains asphalt-dissolving liquid and dissolved liquid asphalt is subjected to distillation to separate and recycle asphalt-dissolving liquid to the process and to obtain recovered asphalt binder. During this process the asphalt-dissolving liquid is distilled at about 50° C. to about 400° C., e.g., 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390 or 400° C., and the recovered asphalt binder is obtained as distillation bottoms.

According to an aspect of the invention, recovered asphalt binder is obtained during distillation in liquid form. In certain embodiments, the recovered asphalt binder can be stored in a tank as pumpable liquid when heated at about 100° C. to about 200° C. to subsequently blend as a precursor material with asphalt binder to produce modified asphalt binder products.

In certain embodiments, the present disclosure provides a method for cooling the recovered asphalt binder following distillation to a temperature of about 25° C. or less to solidify the recovered asphalt binder. In certain embodiments, the solidified recovered asphalt binder is formed to desired sizes and geometries (e.g., molds, briquettes, pellets) to conform to end-user packaging and process integration requirements. In certain embodiments, the solidified recovered asphalt binder is melted into and blended with other asphalt binders to produce modified asphalt binder products.

In certain embodiments, the recovered asphalt binder packaged in solid form can be blended with other liquid asphalt materials as follows. First, preheat liquid asphalt in tank at about 135° C. to about 185° C., e.g., 135, 140, 145, 150, 155, 160, 165, 170, 175, 180 or 185° C. Next, add recovered asphalt binder solid by weight to preheated liquid asphalt until target mass ratio is achieved, e.g., 65-95 wt. % liquid asphalt and 5-35 wt. % recovered asphalt binder solid. Finally, continue to heat liquid asphalt and recovered asphalt binder mixture at about 135° C. to about 185° C. for about 15 minutes to about 180 minutes while mixing until thoroughly blended to produce modified asphalt binder product.

### Modified Asphalt Binder Product

According to an aspect of the invention, recovered asphalt binder can be obtained from asphalt-containing materials with very low particulate matter as well as improved solubility characteristics suitable as a filler to extend a given liquid asphalt grade. In this regard, a recovered asphalt binder with these properties is blended, either in liquid or solid form as previously described herein, with liquid asphalt to produce a modified asphalt binder product.

According to another aspect of the invention, recovered asphalt binder can be obtained from asphalt-containing materials with very low particulate matter as well as improved solubility, stiffening or softening, and performance-enhancing characteristics for use as a modifier to upgrade a given liquid asphalt. In this regard, a recovered asphalt binder with these properties is blended, either in liquid or solid form as previously described herein, with liquid asphalt to produce a modified asphalt binder product.

According to another aspect of the invention, recovered asphalt binder can be obtained from asphalt-containing materials with very low particulate matter as well as improved solubility, stiffening or softening, performance-enhancing and elastic characteristics for use as a modifier to upgrade a given liquid asphalt and reduce or eliminate the need to add polymer compounds to the mixture. Polymer additives are expensive and the binder and process of the present disclosure greatly reduce these costs. In this regard, a recovered asphalt binder with these properties is blended, either in liquid or solid form as previously described herein, with liquid asphalt to produce a modified asphalt binder product.

According to another aspect of the invention, recovered asphalt binder obtained from asphalt-containing materials with any combination of very low particulate matter, improved solubility, improved stiffening or softening characteristics, improved performance-enhancing characteristics or improved elastic properties can be blended with additive(s) and or softening agents, to either directly meet desired liquid asphalt grades and/or characteristics, or as a precursor for use as a filler to extend a given liquid asphalt grade. In this regard, a recovered asphalt binder with the advantageous properties of the material of the present disclosure is blended, either in liquid or solid form, with liquid asphalt to produce a modified asphalt binder product.

According to an aspect of the invention, a large array of modified asphalt binder products can be produced using the recovered asphalt binder, with or without additional modifiers or additives, as a precursor in conjunction with other liquid asphalt products for a variety of uses including, but not limited to, softer liquid asphalts, harder liquid asphalts, roofing asphalt binders, paving asphalt binders, performance graded asphalt binders, performance-enhanced asphalt binders and high-performance asphalt binders.

According to an aspect of the invention, a large array of modified asphalt binder products can be produced using the recovered asphalt binder, with or without additional modifiers or additives, as a precursor in conjunction with other liquid asphalt products for use in a variety of product applications that require liquid asphalt including, but not limited to, roofing products, asphalt roofing shingles, hot mix asphalt, warm mix asphalt, pavement, asphalt emulsions, chip seals, slurry seals and seal coats. In certain embodiments, the present disclosure does not involve using emulsions to contact the asphalt-containing material, emulsification of the asphalt-containing material, or making an emulsified asphalt product.

In certain embodiments, the present disclosure provides a modified asphalt binder product and process for grade bumping of PG asphalt binders.

In certain embodiments, the present disclosure provides a modified asphalt binder product and process for grade bumping of PG asphalt binders with improved elastic properties.

In certain embodiments, a recovered asphalt binder of the present disclosure is blended with base asphalt binder to produce a modified asphalt binder product having a UTI that is higher than the UTI of the base asphalt binder. For example, a PG 52-10 having a UTI of 62 is modified by blending recovered asphalt binder of the present disclosure to produce a modified asphalt binder having a UTI of 64, 66, 68, 70, 72, 74, 76, 78, 80, or higher. In another example, a base binder having a UTI of 80 is modified by blending recovered asphalt binder of the present disclosure to produce a modified asphalt binder having a UTI of 82, 84, 86, 88, 90, 92, 94, 96, 98, 100, or higher. In certain embodiments, a modified asphalt binder product contains about 55-95% wt. % base asphalt binder and about 5-45 wt. % recovered asphalt binder of the present disclosure. In certain embodiments, a modified asphalt binder product contains about 65-90 wt. % base asphalt binder and about 10-35 wt. % recovered asphalt binder of the present disclosure. In certain embodiments, a modified asphalt binder product contains about 75-85 wt. % base asphalt binder and about 15-25 wt. % recovered asphalt binder of the present disclosure. In certain embodiments, a modified asphalt binder product contains about 80 wt. % base asphalt binder and about 20 wt. % recovered asphalt binder of the present disclosure. In certain embodiments, a modified asphalt binder product contains about 90 wt. % base asphalt binder and about 10 wt. % recovered asphalt binder of the present disclosure. In certain embodiments, a modified asphalt binder product contains about 70 wt. % base asphalt binder and about 30 wt. % recovered asphalt binder of the present disclosure.

In certain embodiments, about 5-10 wt % recovered asphalt binder is blended with about 90-95 wt % base asphalt binder to produce a modified asphalt binder with increase in high temperature performance of one grade, e.g., about 10 wt % recovered asphalt binder and about 90 wt % PG 64-22 asphalt binder produces a PG 70-22 modified asphalt binder.

In certain embodiments, about 10-20 wt % recovered asphalt binder is blended with about 80-90 wt % base asphalt binder to produce a modified asphalt binder with increase in high temperature performance of two grades, e.g., about 20 wt % recovered asphalt binder and about 80 wt % PG 64-22 asphalt binder produces a PG 76-22 modified asphalt binder.

In certain embodiments, about 20-30 wt % recovered asphalt binder is blended with about 70-80 wt % base asphalt binder to produce a modified asphalt binder with increase in high temperature performance of three grades, e.g., about 25 wt % recovered asphalt binder and about 75 wt % PG 58-28 asphalt binder produces a PG 76-22 modified asphalt binder

In certain embodiments, the modified asphalt binder product has elastic recovery that is 5-200% higher than elastic recovery of the base liquid asphalt binder. In certain embodiments, the modified asphalt binder product has elastic recovery that is 15-100% higher than elastic recovery of the base liquid asphalt binder. In certain embodiments, the modified asphalt binder product has elastic recovery that is 25-45% higher than elastic recovery of the base liquid asphalt binder. In certain embodiments, the modified asphalt binder product has elastic recovery that is 35-40% higher than elastic recovery of the base liquid asphalt binder.

In one embodiment, a base asphalt binder with elastic recovery according to ASTM D 6084 Procedure B of 22%, when blended with about 5 wt % recovered asphalt binder to produce a modified asphalt binder, resulted in elastic recovery according to ASTM D 6084 Procedure B of 29%, corresponding to an increase in elastic recovery of 32%.

In one embodiment, a base asphalt binder with elastic recovery according to ASTM D 6084 Procedure B of 25%, when blended with about 7 wt % recovered asphalt binder to produce a modified asphalt binder, resulted in elastic recovery according to ASTM D 6084 Procedure B of 30%, corresponding to an increase in elastic recovery of 20%.

In certain embodiments, base asphalt binders with elastic recovery according to ASTM D 6084 Procedure B of 25%, 28%, 28%, 28%, 25% and 22%, when blended with about 10 wt % recovered asphalt binder to produce modified asphalt binders, resulted in elastic recovery according to ASTM D 6084 Procedure B of 30%, 35%, 38%, 38%, 35% and 35%, respectively, corresponding to an increase in elastic recovery of 20%, 25%, 36%, 36%, 40% and 59% respectively.

In one embodiment, a base asphalt binder with elastic recovery according to ASTM D 6084 Procedure B of 25%, when blended with about 12 wt % recovered asphalt binder to produce a modified asphalt binder, resulted in elastic recovery according to ASTM D 6084 Procedure B of 36%, corresponding to an increase in elastic recovery of 44%.

In one embodiment, a base asphalt binder with elastic recovery according to ASTM D 6084 Procedure B of 25%, when blended with about 14 wt % recovered asphalt binder to produce a modified asphalt binder, resulted in elastic recovery according to ASTM D 6084 Procedure B of 38%, corresponding to an increase in elastic recovery of 52%.

In one embodiment, a base asphalt binder with elastic recovery according to ASTM D 6084 Procedure B of 22%, when blended with about 15 wt % recovered asphalt binder to produce a modified asphalt binder, resulted in elastic recovery according to ASTM D 6084 Procedure B of 40%, corresponding to an increase in elastic recovery of 82%.

In one embodiment, a base asphalt binder with elastic recovery according to ASTM D 6084 Procedure B of 25% and 18%, when blended with about 16 wt % recovered asphalt binder to produce a modified asphalt binder, resulted in elastic recovery according to ASTM D 6084 Procedure B of 40% and 36%, respectively, corresponding to an increase in elastic recovery of 60% and 100%, respectively.

In certain embodiments, base asphalt binders with elastic recovery according to ASTM D 6084 Procedure B of 28%, and 28%, when blended with about 20 wt % recovered asphalt binder to produce modified asphalt binders, resulted in elastic recovery according to ASTM D 6084 Procedure B of 40% and 42%, respectively, corresponding to an increase in elastic recovery of 43% and 50%, respectively.

In one embodiment, a base asphalt binder with elastic recovery according to ASTM D 6084 Procedure B of 25%, when blended with about 22 wt % recovered asphalt binder to produce a modified asphalt binder, resulted in elastic recovery according to ASTM D 6084 Procedure B of 45%, corresponding to an increase in elastic recovery of 80%.

In one embodiment, a base asphalt binder with elastic recovery according to ASTM D 6084 Procedure B of 18%, when blended with about 23 wt % recovered asphalt binder to produce a modified asphalt binder, resulted in elastic recovery according to ASTM D 6084 Procedure B of 42%, corresponding to an increase in elastic recovery of 133%.

In one aspect, the invention provides a recovered asphalt binder for direct use to make a final asphalt roof shingle product in a manner consistent with the manufacture of asphalt roofing shingles. In another aspect, the invention provides a recovered asphalt binder with elastomeric properties for direct use to make a final asphalt roof shingle product in a manner consistent with the manufacture of asphalt roofing shingles. In another aspect, the invention provides a recovered asphalt binder for blending with softer and/or harder liquid asphalt materials to formulate a modified asphalt binder product to make a final asphalt roof shingle product in a manner consistent with the manufacture of asphalt roofing shingles. In certain embodiments, the recovered asphalt binder may have elastomeric properties.

More specifically, the present disclosure relates to the materials, products and methods described below. Unless specifically indicated otherwise, parts and percentages are given by weight.

More specifically, the present invention relates to the materials, products and methods described below.

Item 1. A method of making a recovered asphalt binder comprising:

a. contacting an asphalt-containing material with an asphalt-dissolving liquid to form a reaction mixture containing liquid asphalt dissolved into said asphalt-dissolving fluid and undissolved solids;

b. performing a solid-liquid separation of the reaction mixture to produce a solid portion containing bulk solids and a liquid portion containing liquid asphalt dissolved into an asphalt-dissolving fluid and particulate matter;

c. performing liquid-solid separation of the liquid portion to produce a particulate solids portion and a particulate-removed liquid portion of liquid asphalt dissolved into the asphalt-dissolving fluid; and

d. distilling the particulate-removed liquid portion to produce a distilled asphalt-dissolving fluid portion and a recovered asphalt binder portion.

Item 2. The method of item 1, wherein said particulate-removed liquid portion has particulate matter content less than 1 wt. % particulate matter.

Item 3. The method of items 1-2, further comprising recycling the distilled asphalt-dissolving fluid portion to the contacting step.

Item 4. The method of items 1-3, wherein the contacting occurs at a temperature in the range of about 30° C. to about 100° C.

Item 5. The method of items 1-4, wherein the contacting occurs for about 1 minute to about 100 minutes.

Item 6. The method of items 1-5, wherein the asphalt-containing material is in a size of about 35 μm to about 25.4 mm.

Item 7. The method of items 1-6, wherein the asphalt-containing material is a naturally occurring asphalt-containing material.

Item 8. The method of items 1-7, wherein the asphalt-containing material is a post-manufacture product.

Item 9. The method of items 1-8, wherein the asphalt-containing material is Trinidad lake asphalt, rock asphalt, or oil sands.

Item 10. The method of items 1-9, wherein the asphalt-containing material is any asphalt-based manufactured product used for roofing applications or paving applications.

Item 11. The method of items 1-10, wherein the asphalt-dissolving liquid comprises natural turpentine, synthetic turpentine, pine oil, crude stump turpentine, crude wood oil, d-limonene, α-pinene, β-pinene, α-terpineol, (3-terpineol, γ-terpineol, 3-carene, anethole, dipentene (p-mentha-1,8-diene), terpene resins, nopol, pinane, camphene, p-cymene, anisaldehyde, 2-pinane hydroperoxide, 3,7-dimethyl-1,6-octadiene, isobornyl acetate, terpin hydrate, ocimene, 2-pinanol, dihydromyrcenol, isoborneol, a-terpineol, alloocimene, alloocimene alcohols, geraniol, 2-methoxy-2,6-dimethyl-7,8-epoxyoctane, camphor, p-menthan-8-ol, α-terpinyl acetate, citral, citronellol, 7-methoxydihydrocitronellal, 10-camphorsulphonic acid, p-menthene, p-menthan-8-yl acetate, citronellal,7-hydroxydihydrocitronellal, menthol, menthone, a polymer thereof, or a mixture thereof.

Item 12. The method of items 1-11, wherein the asphalt-dissolving liquid comprises α-pinene, β-pinene, α-terpineol, p-cymene, a polymer thereof, or a mixture thereof.

Item 13. The method of items 1-12, wherein the asphalt-dissolving liquid comprises a mixture of: 30-70% α-terpineol, 5-40% β-pinene, 5-50% α-pinene, and 0-30% p-cymene; 40-60% α-terpineol, 10-20% α-pinene, 10-40% β-pinene, and 5-20% p-cymene; 45-55% α-terpineol, 30-40% α-pinene, 5-30% β-pinene, and 10-30% p-cymene; 50% α-terpineol, 25% α-pinene, 20% β-pinene, and 5% p-cymene; 30-70% pine oil, 30-70% α-terpineol, 5-40% β-pinene, 5-50% α-pinene, and 0-30% p-cymene; 15-25% α-terpineol, 10-15% α-pinene, 10-15% β-pinene, and 45-65% p-cymene; 10-20% α-terpineol, 5-10% α-pinene, 5-10% β-pinene, and 40-80% p-cymene; 5-35% a-terpineol, 5-15% a-pinene, 5-15% β-pinene, and 35-85% p-cymene 30-50% pine oil, 40-60% α-terpineol, 10-20% α-pinene, 10-40% β-pinene, and 5-20% p-cymene; or 30-40% pine oil, 45-55% α-terpineol, 30-40% α-pinene, 5-30% β-pinene, and 10-30% p-cymene.

Item 14. The method of items 1-13, wherein the recovered asphalt binder has less than 1.0 wt. % particulate matter.

Item 15. The method of items 1-14, wherein the recovered asphalt binder has less than 0.5 wt. % particulate matter.

Item 16. The method of items 1-15, wherein the recovered asphalt binder has less than 0.2 wt. % particulate matter.

Item 17. The method of items 1-16, wherein the recovered asphalt binder has solubility in trichloroethylene according to ASTM D 2042 greater than about 99%.

Item 18. The method of items 1-17, wherein the recovered asphalt binder has a penetration value of from about 0 to about 300 1/10 mm.

Item 19. The method of items 1-18, wherein the recovered asphalt binder has a penetration value of from about 0 to about 100 1/10 mm.

Item 20. The method of items 1-19, wherein the recovered asphalt binder has a penetration value of from about 1 to about 10 1/10 mm.

Item 21. The method of items 1-20, wherein the recovered asphalt binder has a softening point of about 20° C. to about 200° C.

Item 22. The method of items 1-21, wherein the recovered asphalt binder has a softening point of about 40° C. to about 160° C.

Item 23. The method of items 1-22, wherein the recovered asphalt binder has a softening point of about 55° C. to about 110° C.

Item 24. The method of items 1-23, wherein the recovered asphalt binder has a softening point of about 110° C. to about 155° C.

Item 25. The method of items 1-24, wherein the recovered asphalt binder has high temperature grade of about 30° C. to about 200° C.

Item 26. The method of items 1-25, wherein the recovered asphalt binder has high temperature grade of about 40° C. to about 100° C.

Item 27. The method of items 1-26, wherein the recovered asphalt binder has high temperature grade of about 130° C. to about 190° C.

Item 28. The method of items 1-27, wherein the recovered asphalt binder has low temperature stiffness grade (s-value) of about 20° C. to about −60° C.

Item 29. The method of items 1-28, wherein the recovered asphalt binder has low temperature m-value of about 20° C. to about −60° C.

Item 30. The method of items 1-29, wherein the asphalt-dissolving liquid contains between 0.5% and 49.5% of a non-turpentine aromatic fluid, paraffinic fluid or combination thereof.

Item 31. The method of items 1-30, wherein the non-turpentine aromatic fluid contains aromatic components having a carbon number of C₅ to C₂₀, a boiling point from about 100° C. to about 400° C. and a density of about 0.8 g/mL to about 1.0 g/mL at 15.6° C.

Item 32. The method of items 1-31, wherein the asphalt-dissolving liquid does not contain a non-turpentine aromatic fluid.

Item 33. The method of items 1-30, wherein the non-turpentine paraffinic fluid contains paraffinic components having a carbon number of C₅ to C₂₀, a boiling point from about 50° C. to about 400° C. and a density of about 0.6 g/mL to about 0.9 g/mL at 15.6° C.

Item 34. The method of items 1-33, wherein the asphalt-dissolving liquid does not contain a non-turpentine paraffinic fluid.

Item 35. The method of items 1-34, wherein the contacting comprises contacting the asphalt-dissolving liquid with the asphalt-containing material in a ratio of about 0.5:1 to about 20:1.

Item 36. The method of items 1-35, wherein the contacting comprises contacting the asphalt-dissolving liquid with the asphalt-containing material in a ratio of about 3:1 to about 10:1.

Item 37. The method of items 1-36, wherein the contacting comprises contacting the asphalt-dissolving liquid with the asphalt-containing material in a ratio of about 4:1 to about 7:1.

Item 38. The method of claim 1, further comprising conveying bulk solids to a dryer to obtain dried solids.

Item 39. The method of items 1-38, further comprising condensing asphalt-dissolving liquid evolved during drying of bulk solids to obtain a recycled asphalt-dissolving liquid.

Item 40. The method of items 1-39, further comprising subjecting the dried solids to at least one solid-solid separation step to classify the dried solids according to particle size.

Item 41. The method of items 1-40, wherein the dried solids include at least two solids selected from the group consisting of cellulose, fiberglass, mineral granules, aggregate, sand, clay, dirt, rock, bituminous material, and mineral filler.

Item 42. The method of items 1-41, further comprising contacting the bulk solids and/or the particulate solids portion with the asphalt-dissolving fluid to form a secondary reaction mixture containing liquid asphalt dissolved into the asphalt-dissolving fluid and non-dissolved solids, performing a solid-liquid separation of the secondary reaction mixture to produce a portion of bulk solids and a secondary liquid portion of liquid asphalt dissolved into an asphalt-dissolving fluid and particulate matter, performing a liquid-solid separation of the secondary liquid portion to produce a secondary particulate solids portion and a secondary particulate-removed liquid portion of liquid asphalt dissolved into an asphalt-dissolving fluid, subjecting the particulate-removed secondary liquid portion to distillation to produce distilled asphalt-dissolving fluid portion and a recovered asphalt binder portion.

Item 43. The method of items 1-42, further comprising contacting the asphalt-containing material after it has been contacted with the asphalt-dissolving fluid, with an alcohol, or a mixture of the alcohol with an organic compound with one or more hydroxyl functional group(s) and/or an organic or inorganic solvent, such that a recovery mixture is formed that contains at least a portion of the turpentine liquid that was trapped within the asphalt-containing material and at least one of the alcohol, the organic compound with one or more hydroxyl functional group(s), and/or organic or inorganic solvent.

Item 44. The method of items 1-43, wherein step b) comprises gravity settling, filtration using filter media with a nominal pore size from about 0.4 microns to about 50 microns, multistage filtration using filter media with a nominal pore size from about 0.4 microns to about 50 microns, centrifugation with a gravitational force from about 300 to about 10,000 for about 1 minute to about 30 minutes, or a combination thereof.

Item 45. The method of items 1-44, further comprising cooling the recovered asphalt binder following distillation to a temperature of about 25° C. or less to solidify the recovered asphalt binder.

Item 46. The method of items 1-45, further comprising preheating a liquid asphalt material to be modified with the recovered asphalt binder, adding the recovered asphalt binder to the liquid asphalt material that has been preheated until a target mass ratio between the liquid asphalt material and the recovered asphalt binder is achieved, mixing and heating for at least about 15 minutes to obtain a modified asphalt binder product.

Item 47. The method of items 1-46, wherein said recovered asphalt binder is added in solid form to said liquid asphalt material that has been preheated.

Item 48. The method of items 1-47, wherein the preheating is to a temperature of about 135° C. to about 185° C.

Item 49. The method of items 1-48, wherein the mixing is at a temperature of about 135° C. to about 185° C.

Item 50. The method of items 1-49, wherein the ratio is about 65-95 wt. % liquid asphalt material to be modified with about 5-35 wt. % of the recovered asphalt binder.

Item 51. The method of items 1-50, wherein the mixing is for about 20 minutes to about 180 minutes.

Item 52. A modified asphalt binder product comprising about 5-35 wt. % of a recovered asphalt binder and about 65-95 wt. % liquid asphalt material having a performance grade (PG) and a useful temperature interval (UTI), wherein at least one of PG and elastic recovery is higher in the modified asphalt binder product compared to the liquid asphalt material, or at least one of polymer modifier amount needed to meet a PG requirement, rubber modifier amount needed to meet a PG requirement, and filler additive amount needed to meet a PG requirement is lower in the modified asphalt binder product compared to the liquid asphalt material.

Item 53. The modified asphalt binder product of item 52, wherein PG and elastic recovery are improved in the modified asphalt binder product, compared to PG of the liquid asphalt material.

Item 54. The modified asphalt binder product of items 52-53, wherein PG is improved and the polymer modifier amount needed to meet a PG requirement is lower in the modified asphalt binder product, compared to the PG and polymer modifier amount needed to meet a PG requirement of the liquid asphalt material.

Item 55. The modified asphalt binder product of items 52-54, wherein elastic recovery is higher and the polymer modifier amount needed to meet a PG requirement is lower in the modified asphalt binder product, compared to the elastic recovery and polymer modifier amount needed to meet a PG requirement of the liquid asphalt material.

Item 56. The modified asphalt binder product of items 52-55, wherein PG is improved and the rubber modifier amount needed to meet a PG requirement is lower in the modified asphalt binder product, compared to the PG and rubber modifier amount needed to meet a PG requirement of the liquid asphalt material.

Item 57. The modified asphalt binder product of items 52-56, wherein elastic recovery is higher and the rubber modifier amount needed to meet a PG requirement is lower in the modified asphalt binder product, compared to the elastic recovery and rubber modifier amount needed to meet a PG requirement of the liquid asphalt material.

Item 58. The modified asphalt binder product of items 52-57, wherein PG is improved and the filler additive amount needed to meet a PG requirement is lower in the modified asphalt binder product, compared to the PG and filler additive amount needed to meet a PG requirement of the liquid asphalt material.

Item 59. The modified asphalt binder product of items 52-58, wherein elastic recovery is higher and the filler additive amount needed to meet a PG requirement is lower in the modified asphalt binder product, compared to the elastic recovery and filler additive amount needed to meet a PG requirement of the liquid asphalt material.

Item 60. The modified asphalt binder product of items 52-59, wherein the modified asphalt binder product has at least a one grade improved high temperature PG than the PG of the liquid asphalt material.

Item 61. The modified asphalt binder product of items 52-60, wherein the modified asphalt binder product has a two, three or more grade improved high temperature PG than the PG of the liquid asphalt material.

Item 62. The modified asphalt binder product of items 52-61, wherein the high temperature PG of the liquid asphalt material is improved by at least 3° C. in the modified asphalt binder product than the PG of the liquid asphalt material.

Item 63. The modified asphalt binder product of items 52-62, wherein the high temperature PG of the liquid asphalt material is improved by 6-30° C. in the modified asphalt binder product than the PG of the liquid asphalt material.

Item 64. The modified asphalt binder product of items 52-63, wherein the modified asphalt binder product has at least a one grade improved low temperature PG than the PG of the liquid asphalt material.

Item 65. The modified asphalt binder product of items 52-64, wherein the modified asphalt binder product has a two, three or more grade improved low temperature PG than the PG of the liquid asphalt material.

Item 66. The modified asphalt binder product of item 60, wherein a low temperature stiffness s-value of the liquid asphalt material is not degraded in the modified asphalt binder product that has at least a one grade improved high temperature PG than the PG of the liquid asphalt material.

Item 67. The modified asphalt binder product of item 60, wherein a low temperature stiffness s-value of the liquid asphalt material is improved by at least 3° C. in the modified asphalt binder product that has at least a one grade improved high temperature PG than the PG of the liquid asphalt material.

Item 68. The modified asphalt binder product of item 60, wherein a low temperature stiffness s-value of the liquid asphalt material is improved by 6-18° C. in the modified asphalt binder product that has at least a one grade improved high temperature PG than the PG of the liquid asphalt material.

Item 69. The modified asphalt binder product of item 60, wherein a low temperature m-value of the liquid asphalt material is not degraded in the modified asphalt binder product that has at least a one grade improved high temperature PG than the PG of the liquid asphalt material.

Item 70. The modified asphalt binder product of item 60, wherein a low temperature m-value of the liquid asphalt material is improved by at least 3° C. in the modified asphalt binder product that has at least a one grade improved high temperature PG than the PG of the liquid asphalt material.

Item 71. The modified asphalt binder product of item 60, wherein a low temperature m-value of the liquid asphalt material is improved by 6-18° C. in the modified asphalt binder product that has at least a one grade improved high temperature PG than the PG of the liquid asphalt material.

Item 72. The modified asphalt binder product of items 52-71, wherein the elastic recovery is 15-150% higher in the modified asphalt binder product compared to the elastic recovery of the liquid asphalt material.

Item 73. The modified asphalt binder product of items 52-72, wherein the elastic recovery is 20-45% higher in the modified asphalt binder product compared to the elastic recovery of the liquid asphalt material.

Item 74. The modified asphalt binder product of items 52-73, wherein the modified asphalt binder product has a 6-204 degrees higher UTI than the UTI of the liquid asphalt material.

Item 75. An asphalt roofing product comprising the modified asphalt binder product of items 52-74.

Item 76. An asphalt pavement or paving product comprising the modified asphalt binder product of items 52-75.

Item 77. A method of producing a modified asphalt binder product comprising:

a. preheating a liquid asphalt material having a performance grade (PG),

b. adding a recovered asphalt binder to the liquid asphalt material that has been preheated until a target mass ratio between the liquid asphalt material and the recovered asphalt binder is achieved, and

c. mixing and heating for at least about 15 minutes to obtain a modified asphalt binder product, wherein at least one of PG and elastic recovery is higher in the modified asphalt binder product compared to the liquid asphalt material, or wherein at least one of polymer modifier amount needed to meet a PG requirement, rubber modifier amount needed to meet a PG requirement, and filler additive amount needed to meet a PG requirement is lower in the modified asphalt binder product compared to the liquid asphalt material.

Item 78. The method of item 77, wherein the recovered asphalt binder has particulate matter content less than 1 wt. % particulate matter.

Item 79. The method of items 77-78, wherein the recovered asphalt binder has less than 0.5 wt. % particulate matter.

Item 80. The method of items 77-79, wherein the recovered asphalt binder has less than 0.2 wt. % particulate matter.

Item 81. The method of items 77-80, wherein the recovered asphalt binder has solubility in trichloroethylene according to ASTM D 2042 greater than about 99%.

Item 82. The method of items 77-81, wherein the recovered asphalt binder has a penetration value of from about 0 to about 300 1/10 mm.

Item 83. The method of items 77-82, wherein the recovered asphalt binder has a penetration value of from about 1 to about 100 1/10 mm.

Item 84. The method of items 77-83, wherein the recovered asphalt binder has a softening point of about 20° C. to about 200° C.

Item 85. The method of items 77-84, wherein the recovered asphalt binder has a softening point of about 40° C. to about 160° C.

Item 86. The method of items 77-85, wherein the recovered asphalt binder has a softening point of about 55° C. to about 110° C.

Item 87. The method of items 77-86, wherein the recovered asphalt binder has a softening point of about 110° C. to about 155° C.

Item 88. The method of items 77-87, wherein the recovered asphalt binder has high temperature grade of about 30° C. to about 200° C.

Item 89. The method of items 77-88, wherein the recovered asphalt binder has high temperature grade of about 40° C. to about 100° C.

Item 90. The method of items 77-89, wherein the recovered asphalt binder has high temperature grade of about 130° C. to about 190° C.

Item 91. The method of items 77-90, wherein the recovered asphalt binder has low temperature stiffness grade (s-value) of about 20° C. to about −60° C.

Item 92. The method of items 77-91, wherein the recovered asphalt binder has low temperature m-value of about 20° C. to about −60° C.

Item 93. The method of items 77-92, wherein said recovered asphalt binder is added in solid form to said liquid asphalt material that has been preheated.

Item 94. The method of items 77-93, wherein the preheating is to a temperature of about 135° C. to about 185° C.

Item 95. The method of items 77-94, wherein the mixing is at a temperature of about 135° C. to about 185° C.

Item 96. The method of items 77-95, wherein the mixing is for about 20 minutes to about 180 minutes.

Item 97. The method of items 77-96, wherein PG and elastic recovery are higher in the modified asphalt binder product, compared to PG of the liquid asphalt material.

Item 98. The method of items 77-97, wherein PG is improved and the polymer modifier amount needed to meet a PG requirement is lower in the modified asphalt binder product, compared to the PG and polymer modifier amount needed to meet a PG requirement of the liquid asphalt material.

Item 99. The method of items 77-98, wherein elastic recovery is higher and the polymer modifier amount needed to meet a PG requirement is lower in the modified asphalt binder product, compared to the elastic recovery and polymer modifier amount needed to meet a PG requirement of the liquid asphalt material.

Item 100. The method of items 77-99, wherein elastic recovery is higher and the rubber amount needed to meet a PG requirement is lower in the modified asphalt binder product, compared to the elastic recovery and rubber amount needed to meet a PG requirement of the liquid asphalt material.

Item 101. The method of items 77-100, wherein PG is improved and the rubber modifier amount needed to meet a PG requirement is lower in the modified asphalt binder product, compared to the PG and rubber modifier amount needed to meet a PG requirement of the liquid asphalt material.

Item 102. The method of items 77-101, wherein PG is improved and the filler additive amount needed to meet a PG requirement is lower in the modified asphalt binder product, compared to the PG and filler additive amount needed to meet a PG requirement of the liquid asphalt material.

Item 103. The method of items 77-102, wherein elastic recovery is higher and the filler additive amount needed to meet a PG requirement is lower in the modified asphalt binder product, compared to the elastic recovery and filler additive amount needed to meet a PG requirement of the liquid asphalt material.

Item 104. The method of items 77-103, wherein the modified asphalt binder product has at least a one grade higher high temperature PG than the PG of the liquid asphalt material.

Item 105. The method of items 77-104, wherein the modified asphalt binder product has a two, three or more grade higher high temperature PG than the PG of the liquid asphalt material.

Item 106. The method of items 77-105, wherein the high temperature PG of the liquid asphalt material is improved by at least 3° C. in the modified asphalt binder product than the PG of the liquid asphalt material.

Item 107. The method of items 77-106, wherein the high temperature PG of the liquid asphalt material is improved by 6-30° C. in the modified asphalt binder product than the PG of the liquid asphalt material.

Item 108. The method of item 104, wherein a low temperature stiffness s-value of the liquid asphalt material is not degraded in the modified asphalt binder product that has at least one grade higher high temperature PG than the PG of the liquid asphalt material.

Item 109. The method of item 104, wherein a low temperature stiffness s-value of the liquid asphalt material is improved by at least 3° C. in the modified asphalt binder product that has at least one grade higher high temperature PG than the PG of the liquid asphalt material.

Item 110. The method of item 104, wherein a low temperature stiffness s-value of the liquid asphalt material is improved by 6-18 ° C. in the modified asphalt binder product that has at least one grade higher high temperature PG than the PG of the liquid asphalt material.

Item 111. The method of item 104, wherein a low temperature m-value of the liquid asphalt material is not degraded in the modified asphalt binder product that has at least one grade higher high temperature PG than the PG of the liquid asphalt material.

Item 112. The method of item 104, wherein a low temperature m-value of the liquid asphalt material is improved by at least 3° C. in the modified asphalt binder product that has at least one grade higher high temperature PG than the PG of the liquid asphalt material.

Item 113. The method of item 104, wherein a low temperature m-value of the liquid asphalt material is improved by 6-18° C. in the modified asphalt binder product that has at least one grade higher high temperature PG than the PG of the liquid asphalt material.

Item 114. The method of items 77-113, wherein the elastic recovery is 15-150% higher in the modified asphalt binder product compared to the elastic recovery of the liquid asphalt material.

Item 115. The method of items 77-114, wherein the elastic recovery is 20-45% higher in the modified asphalt binder product compared to the elastic recovery of the liquid asphalt material.

Item 116. The method of items 77-115, wherein the modified asphalt binder product has a 6-204 degrees higher UTI than the UTI of the liquid asphalt material.

Item 117. A recovered asphalt binder comprising a distilled liquid asphalt, wherein the recovered asphalt binder has less than 1.0 wt. % particulate matter, solubility in trichloroethylene according to ASTM D 2042 greater than about 99%, a penetration value of from about 0 to about 300 1/10 mm, a softening point of about 20° C. to about 200° C., a high temperature grade of about 30° C. to about 200° C., a low temperature stiffness grade (s-value) of about 20° C. to about −60° C., and a low temperature m-value of about 20° C. to about −60° C.

Item 118. An asphalt roofing shingle or other manufactured asphalt-containing roofing product comprising the recovered asphalt binder of item 117.

Item 119. An asphalt pavement or other manufactured asphalt-containing paving product comprising the recovered asphalt binder of item 117.

This invention is illustrated by the following examples which are merely for the purpose of illustration and are not to be regarded as limiting the scope of the invention or the manner in which it can be practiced.

### EXAMPLES

### Example 1

In this example, penetration values of commercially-sourced paving asphalt binders are compared to penetration values determined according to ASTM D 5 for recovered asphalt binder made using a blend of turpentine fluids according to the present disclosure. The following table shows typical penetration values for the softest and hardest commercial petroleum-derived paving asphalt binders as well as minimum, maximum, average and median penetration values for the recovered asphalt binder.

TABLE 3

| | Penetration | | | | | |
|---|---|---|---|---|---|---|
| | Softest | Hardest | Recovered | Recovered | Recovered | Recovered |
| | Paving | Paving | Asphalt | Asphalt | Asphalt | Asphalt |
| | Asphalt | Asphalt | Binder | Binder | Binder | Binder |
| | Binder | Binder | Minimum | Maximum | Average | Median |
| | units | | | | | |
| | 1/10 mm | 1/10 mm | 1/10 mm | 1/10 mm | 1/10 mm | 1/10 mm |
| 25° C. (77° F.) | 200-300 | 40-50 | 0 | 8 | 3.7 | 4 |

### Example 2

In this example, penetration values of commercially-sourced paving asphalt binders are compared to penetration values determined according to ASTM D 5 for recovered asphalt binder made using a blend of turpentine fluids and non-turpentine aromatic fluids according to the present disclosure. The following table shows typical penetration values for the softest and hardest commercial petroleum-derived paving asphalt binders as well as minimum, maximum, average and median penetration values for the recovered asphalt binder.

TABLE 4

| | Penetration | | | | | |
|---|---|---|---|---|---|---|
| | Softest | Hardest | Recovered | Recovered | Recovered | Recovered |
| | Paving | Paving | Asphalt | Asphalt | Asphalt | Asphalt |
| | Asphalt | Asphalt | Binder | Binder | Binder | Binder |
| | Binder | Binder | Minimum | Maximum | Average | Median |
| | units | | | | | |
| | 1/10 mm | 1/10 mm | 1/10 mm | 1/10 mm | 1/10 mm | 1/10 mm |
| 25° C. (77° F.) | 200-300 | 40-50 | 3 | 8 | 5.5 | 5.5 |

### Example 3

In this example, penetration values of commercially-sourced paving asphalt binders are compared to penetration values determined according to ASTM D 5 for recovered asphalt binder made using a blend of turpentine fluids and non-turpentine paraffinic fluids according to the present disclosure. The following table shows typical penetration values for the softest and hardest commercial petroleum-derived paving asphalt binders as well as minimum, maximum, average and median penetration values for the recovered asphalt binder.

TABLE 5

| | Penetration | | | | | |
|---|---|---|---|---|---|---|
| | Softest | Hardest | Recovered | Recovered | Recovered | Recovered |
| | Paving | Paving | Asphalt | Asphalt | Asphalt | Asphalt |
| | Asphalt | Asphalt | Binder | Binder | Binder | Binder |
| | Binder | Binder | Minimum | Maximum | Average | Median |
| | units | | | | | |
| | 1/10 mm | 1/10 mm | 1/10 mm | 1/10 mm | 1/10 mm | 1/10 mm |
| 25° C. (77° F.) | 200-300 | 40-50 | 1 | 2 | 1.5 | 1.5 |

### Example 4

In this example, penetration values of roofing asphalt binder Types I-IV as defined by ASTM D 312 are compared to penetration values determined according to ASTM D 5 for a recovered asphalt binder made using a blend of turpentine liquids according to the present disclosure.

TABLE 6

| | | | | | | | | | Recovered |
|---|---|---|---|---|---|---|---|---|---|
| | | | | | | | | | Asphalt |
| | Type I | | Type II | | Type III | | Type IV | | Binder |
| | Penetration | | | | | | | | |
| | Min | Max | Min | Max | Min | Max | Min | Max | |
| | units | | | | | | | | |
| | 1/10 mm | 1/10 mm | 1/10 mm | 1/10 mm | 1/10 mm | 1/10 mm | 1/10 mm | 1/10 mm | 1/10 mm |
| 0° C. (32° F.) | 3 | — | 6 | — | 6 | — | 6 | — | 5 |
| 25° C. (77° F.) | 18 | 60 | 18 | 40 | 15 | 35 | 12 | 25 | 5 |
| 46° C. (115° F.) | 90 | 180 | — | 100 | — | 90 | — | 75 | 2 |

### Example 5

In this example, the softening points of roofing asphalt binder Types I-IV as defined by ASTM D 312 are compared to softening points determined according to ASTM D 36 for recovered asphalt binder made using a blend of turpentine liquids according to the present disclosure.

TABLE 7

| | Type I | | Type II | | Type III | | Type IV | | | | | |
|---|---|---|---|---|---|---|---|---|---|---|---|---|
| | Roofing | | Roofing | | Roofing | | Roofing | | Recovered | Recovered | Recovered | Recovered |
| | Asphalt | | Asphalt | | Asphalt | | Asphalt | | Asphalt | Asphalt | Asphalt | Asphalt |
| | Binder | | Binder | | Binder | | Binder | | Binder | Binder | Binder | Binder |
| Softening Point | Min | Max | Min | Max | Min | Max | Min | Max | Min | Max | Average | Median |
| units, ° C. | 57 | 66 | 70 | 80 | 85 | 96 | 99 | 107 | 104 | 142 | 128 | 129 |
| units, ° F. | 135 | 151 | 158 | 176 | 185 | 205 | 210 | 225 | 219 | 287 | 262 | 264 |

### Example 6

In this example, the softening points of roofing asphalt binder Types I-IV as defined by ASTM D 312 are compared to softening points determined according to ASTM D 36 for recovered asphalt binder made using a blend of turpentine fluids and non-turpentine aromatic fluids according to the present disclosure.

TABLE 8

| | Type I | | Type II | | Type III | | Type IV | | | | | |
|---|---|---|---|---|---|---|---|---|---|---|---|---|
| | Roofing | | Roofing | | Roofing | | Roofing | | Recovered | Recovered | Recovered | Recovered |
| | Asphalt | | Asphalt | | Asphalt | | Asphalt | | Asphalt | Asphalt | Asphalt | Asphalt |
| | Binder | | Binder | | Binder | | Binder | | Binder | Binder | Binder | Binder |
| Softening Point | Min | Max | Min | Max | Min | Max | Min | Max | Min | Max | Average | Median |
| units, ° C. | 57 | 66 | 70 | 80 | 85 | 96 | 99 | 107 | 112 | 124 | 118 | 118 |
| units, ° F. | 135 | 151 | 158 | 176 | 185 | 205 | 210 | 225 | 234 | 255 | 244 | 244 |

### Example 7

In this example, the softening points of roofing asphalt binder Types I-IV as defined by ASTM D 312 are compared to softening points determined according to ASTM D 36 for recovered asphalt binder made using a blend of turpentine fluids and non-turpentine paraffinic fluids according to the present disclosure.

TABLE 9

| | Type I | | Type II | | Type III | | Type IV | | | | | |
|---|---|---|---|---|---|---|---|---|---|---|---|---|
| | Roofing | | Roofing | | Roofing | | Roofing | | Recovered | Recovered | Recovered | Recovered |
| | Asphalt | | Asphalt | | Asphalt | | Asphalt | | Asphalt | Asphalt | Asphalt | Asphalt |
| | Binder | | Binder | | Binder | | Binder | | Binder | Binder | Binder | Binder |
| Softening Point | Min | Max | Min | Max | Min | Max | Min | Max | Min | Max | Average | Median |
| units, ° C. | 57 | 66 | 70 | 80 | 85 | 96 | 99 | 107 | 124 | 132 | 128 | 128 |
| units, ° F. | 135 | 151 | 158 | 176 | 185 | 205 | 210 | 225 | 255 | 270 | 262 | 262 |

### Example 8

In this example, a recovered asphalt binder made using a blend of turpentine liquids according to the present disclosure is described in terms of the performance graded asphalt binder specification.

PG asphalt binders have a typical high temperature grade range from 52° C. to 76° C. The high temperature grade is measured using a 25 millimeter (mm) dynamic shear rheometer (DSR) according to AASHTO T 315. PG binders also have a typical low temperature grade range from −10° C. to −40° C. The low temperature grade is measured using a bending beam rheometer (BBR) according to AASHTO T 313. The low temperature grade can alternatively be measured using a 4 mm DSR according to a method development by Western Research Institute.

The high temperature grade of the recovered asphalt binder was determined to be 171.0° C. at 1.0 kPa and 161.1° C. at 2.2 kPa by extrapolating 25 mm DSR test data that was performed at a temperature of 130° C. or slightly lower; given the stiffness of the recovered asphalt binder, direct measurement of the corresponding high temperature could not be performed using the DSR instrument. The recovered asphalt binder was determined to have low temperature stiffness, i.e., s-value, grade of −24.8° C. and low temperature m-value, i.e., slope of s-value, grade of +6.5° C. using the 4 mm DSR test method. In this example, the recovered asphalt binder is said to be m-controlled with a performance grade of PG 161.1+6.5.

### Example 9

In this example, a recovered asphalt binder made using a blend of turpentine liquids according to the present disclosure is described in terms of the performance graded asphalt binder specification. The high temperature grade of the recovered asphalt binder was determined to be 183.9° C. at 1.0 kPa and 171.0° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −34.4° C. and a low temperature m-value grade of 12.2° C. as measured by BBR according to AASHTO T 313. In this example, the recovered asphalt binder is said to be m-controlled with a performance grade of PG 171.0+12.2.

### Example 10

In this example, a recovered asphalt binder made using a blend of turpentine liquids according to the present disclosure is described in terms of the performance graded asphalt binder specification. The high temperature grade of the recovered asphalt binder was determined to be 150.3° C. at 1.0 kPa and 144.8° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −21.9° C. and a low temperature m-value grade of 20.7° C. as measured by BBR according to AASHTO T 313. In this example, the recovered asphalt binder is said to be m-controlled with a performance grade of PG 144.8+20.7.

### Example 11

In this example, a recovered asphalt binder made using a blend of turpentine liquids according to the present disclosure is described in terms of the performance graded asphalt binder specification. The high temperature grade of the recovered asphalt binder was determined to be 144.2° C. at 1.0 kPa and 138.6° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −12.3° C. and a low temperature m-value grade of 17.7° C. as measured by BBR according to AASHTO T 313. In this example, the recovered asphalt binder is said to be m-controlled with a performance grade of PG 138.6+17.7.

### Example 12

In this example, a recovered asphalt binder made using a blend of turpentine liquids according to the present disclosure is described in terms of the performance graded asphalt binder specification. The high temperature grade of the recovered asphalt binder was determined to be 174.2° C. at 1.0 kPa and 161.5° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −20.2° C. and a low temperature m-value grade of 19.5° C. as measured by BBR according to AASHTO T 313. In this example, the recovered asphalt binder is said to be m-controlled with a performance grade of PG 161.5+19.5.

### Example 13

In this example, a recovered asphalt binder made using a blend of turpentine liquids according to the present disclosure is described in terms of the performance graded asphalt binder specification. The high temperature grade of the recovered asphalt binder was determined to be 165.7° C. at 1.0 kPa and 152.1° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −34.4° C. and a low temperature m-value grade of 3.3° C. as measured by BBR according to AASHTO T 313. In this example, the recovered asphalt binder is said to be m-controlled with a performance grade of PG 152.1+3.3.

### Example 14

In this example, a recovered asphalt binder made using a blend of turpentine liquids according to the present disclosure is described in terms of the performance graded asphalt binder specification. The high temperature grade of the recovered asphalt binder was determined to be 199.6° C. at 1.0 kPa and 185.0° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −30.1° C. and a low temperature m-value grade of 8.0° C. as measured by BBR according to AASHTO T 313. In this example, the recovered asphalt binder is said to be m-controlled with a performance grade of PG 185.0+8.0.

### Example 15

In this example, a recovered asphalt binder made using a blend of turpentine liquids according to the present disclosure is described in terms of the performance graded asphalt binder specification. The high temperature grade of the recovered asphalt binder was determined to be 174.8° C. at 1.0 kPa and 162.0° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −34.0° C. and a low temperature m-value grade of 8.3° C. as measured by BBR according to AASHTO T 313. In this example, the recovered asphalt binder is said to be m-controlled with a performance grade of PG 162.0+8.3.

### Example 16

In this example, a recovered asphalt binder made using a blend of turpentine liquids according to the present disclosure is described in terms of the performance graded asphalt binder specification. The high temperature grade of the recovered asphalt binder was determined to be 157.3° C. at 1.0 kPa and 145.1° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −32.7° C. and a low temperature m-value grade of 1.7° C. as measured by BBR according to AASHTO T 313. In this example, the recovered asphalt binder is said to be m-controlled with a performance grade of PG 145.1+1.7.

### Example 17

In this example, a recovered asphalt binder made using a blend of turpentine liquids according to the present disclosure is described in terms of the performance graded asphalt binder specification. The high temperature grade of the recovered asphalt binder was determined to be 149.5° C. at 1.0 kPa and 138.2° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −19.8° C. and a low temperature m-value grade of −1.7° C. as measured by BBR according to AASHTO T 313. In this example, the recovered asphalt binder is said to be m-controlled with a performance grade of PG 138.2-1.7.

### Example 17

In this example, a recovered asphalt binder made using a blend of turpentine liquids according to the present disclosure is described in terms of the performance graded asphalt binder specification. The high temperature grade of the recovered asphalt binder was determined to be 143.6° C. at 1.0 kPa and 135.1° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −20.8° C. and a low temperature m-value grade of 0.6° C. as measured by BBR according to AASHTO T 313. In this example, the recovered asphalt binder is said to be m-controlled with a performance grade of PG 135.1+0.6.

### Example 18

In this example, a recovered asphalt binder made using a blend of turpentine liquids according to the present disclosure is described in terms of the performance graded asphalt binder specification. The high temperature grade of the recovered asphalt binder was determined to be 127.9° C. at 1.0 kPa and 121.4° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of 1.6° C. and a low temperature m-value grade of 1.6° C. as measured by BBR according to AASHTO T 313. In this example, the recovered asphalt binder is said to be neither s-controlled or m-controlled with a performance grade of PG 121.4+1.6.

### Example 19

In this example, a recovered asphalt binder made using a blend of turpentine liquids according to the present disclosure is described in terms of the performance graded asphalt binder specification. The high temperature grade of the recovered asphalt binder was determined to be 90.3° C. at 1.0 kPa and 84.2° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −10.9° C. and a low temperature m-value grade of −14.7° C. as measured by BBR according to AASHTO T 313. In this example, the recovered asphalt binder is said to be s-controlled with a performance grade of PG 84.2-10.9.

### Example 20

In this example, a recovered asphalt binder made using a blend of turpentine liquids and non-turpentine aromatic liquids according to the present disclosure is described in terms of the performance graded asphalt binder specification. The high temperature grade of the recovered asphalt binder was determined to be 171.9° C. at 1.0 kPa and 163.8° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −19.0° C. and a low temperature m-value grade of 31.0° C. as measured by BBR according to AASHTO T 313. In this example, the recovered asphalt binder is said to be m-controlled with a performance grade of PG 163.8+31.0.

### Example 21

In this example, a recovered asphalt binder made using a blend of turpentine liquids and non-turpentine aromatic liquids according to the present disclosure is described in terms of the performance graded asphalt binder specification. The high temperature grade of the recovered asphalt binder was determined to be 165.1° C. at 1.0 kPa and 158.1° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −23.4° C. and a low temperature m-value grade of 38.0° C. as measured by BBR according to AASHTO T 313. In this example, the recovered asphalt binder is said to be m-controlled with a performance grade of PG 158.1+38.0.

### Example 22

In this example, a recovered asphalt binder made using a blend of turpentine liquids and non-turpentine aromatic liquids according to the present disclosure is described in terms of the performance graded asphalt binder specification. The high temperature grade of the recovered asphalt binder was determined to be 185.2° C. at 1.0 kPa and 171.3° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −33.0° C. and a low temperature m-value grade of 7.7° C. as measured by BBR according to AASHTO T 313. In this example, the recovered asphalt binder is said to be m-controlled with a performance grade of PG 171.3+7.7.

### Example 23

In this example, a recovered asphalt binder made using a blend of turpentine liquids and non-turpentine aromatic liquids according to the present disclosure is described in terms of the performance graded asphalt binder specification. The high temperature grade of the recovered asphalt binder was determined to be 184.8° C. at 1.0 kPa and 171.5° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −30.9° C. and a low temperature m-value grade of 9.1° C. as measured by BBR according to AASHTO T 313. In this example, the recovered asphalt binder is said to be m-controlled with a performance grade of PG 171.5+9.1.

### Example 24

In this example, a recovered asphalt binder made using a blend of turpentine liquids and non-turpentine paraffinic liquids according to the present disclosure is described in terms of the performance graded asphalt binder specification. The high temperature grade of the recovered asphalt binder was determined to be 181.5° C. at 1.0 kPa and 167.6° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −29.3° C. and a low temperature m-value grade of 14.0° C. as measured by BBR according to AASHTO T 313. In this example, the recovered asphalt binder is said to be m-controlled with a performance grade of PG 167.6+14.0.

### Example 25

In this example, a recovered asphalt binder made using a blend of turpentine liquids and non-turpentine paraffinic liquids according to the present disclosure is described in terms of the performance graded asphalt binder specification. The high temperature grade of the recovered asphalt binder was determined to be 189.9° C. at 1.0 kPa and 176.2° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −31.7° C. and a low temperature m-value grade of 7.7° C. as measured by BBR according to AASHTO T 313. In this example, the recovered asphalt binder is said to be m-controlled with a performance grade of PG 176.2+7.7.

### Example 26

In this example, a recovered asphalt binder made using a blend of turpentine liquids and non-turpentine paraffinic liquids according to the present disclosure is described in terms of the performance graded asphalt binder specification. The high temperature grade of the recovered asphalt binder was determined to be 175.1° C. at 1.0 kPa and 162.3° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −33.3° C. and a low temperature m-value grade of 8.1° C. as measured by BBR according to AASHTO T 313. In this example, the recovered asphalt binder is said to be m-controlled with a performance grade of PG 162.3+8.1.

EXAMPLE 27

In this example, a recovered asphalt binder made using a blend of turpentine liquids and non-turpentine paraffinic liquids according to the present disclosure is described in terms of the performance graded asphalt binder specification. The high temperature grade of the recovered asphalt binder was determined to be 179.8° C. at 1.0 kPa and 167.8° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −33.7° C. and a low temperature m-value grade of 8.1° C. as measured by BBR according to AASHTO T 313. In this example, the recovered asphalt binder is said to be m-controlled with a performance grade of PG 167.8+8.1.

### Example 28

In this example, 90 wt % recovered asphalt binder made using a blend of turpentine liquids according to the present disclosure is blended with 10 wt % RAFFEX® 120 aromatic process oil manufactured by San Joaquin Refining Company, Inc. and described in terms of the penetration value and softening point.

Before blending with 10 wt % RAFFEX® 120 aromatic process oil, the penetration value of the recovered asphalt binder was determined to be 0 1/10 mm according to ASTM D 5 and the softening point of the recovered asphalt binder was determined to be 129° C. (264.2° F.) according to ASTM D 36.

After blending, the penetration value of the formulated recovered asphalt binder and aromatic process oil blend in this example was determine to be 4 1/10 mm according to ASTM D Sand the softening point of the recovered asphalt binder was determined to be 106° C. (222.8° F.) according to ASTM D 36.

In this example, the penetration of the recovered asphalt binder increased by 4 1/10 mm and the softening point increased by 23° C. (41.4° F.) by blending 90 wt % recovered asphalt binder with 10 wt % RAFFEX® 120 aromatic process oil.

### Example 29

In this example, 80 wt % recovered asphalt binder made using a blend of turpentine liquids according to the present disclosure is blended with 20 wt % RAFFEX® 120 aromatic process oil manufactured by San Joaquin Refining Company, Inc. and described in terms of the penetration value and softening point.

Before blending with 20 wt % RAFFEX® 120 aromatic process oil, the penetration value of the recovered asphalt binder was determined to be 0 1/10 mm according to ASTM D 5 and the softening point of the recovered asphalt binder was determined to be 129° C. (264.2° F.) according to ASTM D 36.

After blending, the penetration value of the formulated recovered asphalt binder and aromatic process oil blend in this example was determine to be 14 1/10 mm according to ASTM D 5. The softening point of the recovered asphalt binder was determined to be 89° C. (192.2° F.) according to ASTM D 36.

In this example, the penetration of the recovered asphalt binder increased by 14 1/10 mm and the softening point increased by 40° C. (64° F.) by blending 80 wt % recovered asphalt binder with 20 wt % RAFFEX® 120 aromatic process oil.

### Example 30

In this example, 90 wt % recovered asphalt binder made using a blend of turpentine liquids according to the present disclosure is blended with 10 wt % RAFFEX® 200 aromatic process oil manufactured by San Joaquin Refining Company, Inc. and described in terms of the penetration value and softening point.

Before blending with 10 wt % RAFFEX® 200 aromatic process oil, the penetration value of the recovered asphalt binder was determined to be 0 1/10 mm according to ASTM D 5 and the softening point of the recovered asphalt binder was determined to be 129° C. (264.2° F.) according to ASTM D 36.

After blending, the penetration value of the formulated recovered asphalt binder and aromatic process oil blend in this example was determine to be 4 1/10 mm according to ASTM D 5. The softening point of the recovered asphalt binder was determined to be 103° C. (217.4° F.) according to ASTM D 36.

In this example, the penetration of the recovered asphalt binder increased by 4 1/10 mm and the softening point increased by 26° C. (52.8° F.) by blending 90 wt % recovered asphalt binder with 10 wt % RAFFEX® 200 aromatic process oil.

### Example 31

In this example, 80 wt % recovered asphalt binder made using a blend of turpentine liquids according to the present disclosure is blended with 20 wt % RAFFEX® 200 aromatic process oil manufactured by San Joaquin Refining Company, Inc. and described in terms of the penetration value and softening point.

Before blending with 20 wt % RAFFEX® 200 aromatic process oil, the penetration value of the recovered asphalt binder was determined to be 0 1/10 mm according to ASTM D 5 and the softening point of the recovered asphalt binder was determined to be 129° C. (264.2° F.) according to ASTM D 36.

After blending, the penetration value of the formulated recovered asphalt binder and aromatic process oil blend in this example was determine to be 12 1/10 mm according to ASTM D 5. The softening point of the recovered asphalt binder was determined to be 90° C. (194° F.) according to ASTM D 36.

In this example, the penetration of the recovered asphalt binder increased by 12 1/10 mm and the softening point increased by 39° C. (63.2° F.) by blending 80 wt % recovered asphalt binder with 20 wt % RAFFEX® 200 aromatic process oil.

### Example 32

In this example, 90 wt % recovered asphalt binder made using a blend of turpentine liquids according to the present disclosure is blended with 10 wt % RAFFEX® 120 aromatic process oil manufactured by San Joaquin Refining Company, Inc. and described in terms of the performance graded asphalt binder specification.

Before blending with 10 wt % RAFFEX® 120 aromatic process oil, the high temperature grade of the recovered asphalt binder was determined to be 150.3° C. at 1.0 kPa and 144.8° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −21.9° C. and a low temperature m-value grade of 20.7° C. as measured by BBR according to AASHTO T 313. In this example, the recovered asphalt binder is said to be m-controlled with a performance grade of PG 144.8+20.7.

After blending, the high temperature grade of the formulated recovered asphalt binder and aromatic process oil blend in this example was determined to be 133.6° C. at 1.0 kPa and 128.4° C. at 2.2 kPa by extrapolating 25 mm DSR data obtained according to AASHTO T 315 at a temperature of 130° C. or slightly lower depending on instrument constraints as described previously. The formulated recovered asphalt binder and aromatic process oil blend in this example was determined to have a low temperature s-value grade of −24.9° C. and a low temperature m-value grade of 0.8° C. as measured by BBR according to AASHTO T 313. In this example, the formulated recovered asphalt binder and aromatic process oil blend is said to be m-controlled with a performance grade of PG 128.4+0.8.

In this example, the high temperature grade of the recovered asphalt binder decreased 16.4° C. by blending 90 wt % recovered asphalt binder with 10 wt % RAFFEX® 120 aromatic process oil.

In this example, the low temperature s-value and m-value grades of the recovered asphalt binder decreased by −3.0 and −19.9° C., respectively, by blending 90 wt % recovered asphalt binder with 10 wt % RAFFEX® 120 aromatic process oil.

### Example 33

In this example, 80 wt % recovered asphalt binder made using a blend of turpentine liquids according to the present disclosure is blended with 20 wt % RAFFEX® 120 aromatic process oil manufactured by San Joaquin Refining Company, Inc. and described in terms of the performance graded asphalt binder specification.

Before blending with 20 wt % RAFFEX® 120 aromatic process oil, the high temperature grade of the recovered asphalt binder was determined to be 150.3° C. at 1.0 kPa and 144.8° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −21.9° C. and a low temperature m-value grade of 20.7° C. as measured by BBR according to AASHTO T 313. In this example, the recovered asphalt binder is said to be m-controlled with a performance grade of PG 144.8+20.7.

After blending, the high temperature grade of the formulated recovered asphalt binder and aromatic process oil blend in this example was determined to be 114.4° C. at 1.1 kPa and 104.2° C. kPa at 2.2 kPa by extrapolating 25 mm DSR data obtained according to AASHTO T 315 at a temperature of 130° C. or slightly lower depending on instrument constraints as described previously. The formulated recovered asphalt binder and aromatic process oil blend in this example was determined to have a low temperature s-value grade of −33.2° C. and a low temperature m-value grade of −22.4° C. as measured by BBR according to AASHTO T 313. In this example, the formulated recovered asphalt binder and aromatic process oil blend is said to be m-controlled with a performance grade of PG 104.2-22.4.

In this example, the high temperature grade of the recovered asphalt binder decreased 40.6° C. by blending 80 wt % recovered asphalt binder with 20 wt % RAFFEX® 120 aromatic process oil.

In this example, the low temperature s-value and m-value grades of the recovered asphalt binder decreased by −11.3 and −43.1° C., respectively, by blending 80 wt % recovered asphalt binder with 20 wt % RAFFEX® 120 aromatic process oil.

### Example 34

In this example, 90 wt % recovered asphalt binder made using a blend of turpentine liquids according to the present disclosure is blended with 10 wt % RAFFEX® 200 aromatic process oil manufactured by San Joaquin Refining Company, Inc. and described in terms of the performance graded asphalt binder specification.

Before blending with 10 wt % RAFFEX® 200 aromatic process oil, the high temperature grade of the recovered asphalt binder was determined to be 150.3° C. at 1.0 kPa and 144.8° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −21.9° C. and a low temperature m-value grade of 20.7° C. as measured by BBR according to AASHTO T 313. In this example, the recovered asphalt binder is said to be m-controlled with a performance grade of PG 144.8+20.7.

After blending, the high temperature grade of the formulated recovered asphalt binder and aromatic process oil blend in this example was determined to be 135.7° C. at 1.0 kPa and 129.6° C. at 2.2 kPa by extrapolating 25 mm DSR data obtained according to AASHTO T 315 at a temperature of 130° C. or slightly lower depending on instrument constraints as described previously. The formulated recovered asphalt binder and aromatic process oil blend in this example was determined to have a low temperature s-value grade of −29.6° C. and a low temperature m-value grade of 1.6° C. as measured by BBR according to AASHTO T 313. In this example, the formulated recovered asphalt binder and aromatic process oil blend is said to be m-controlled with a performance grade of PG 129.6+1.6.

In this example, the high temperature grade of the recovered asphalt binder decreased 15.2° C. by blending 90 wt % recovered asphalt binder with 10 wt % RAFFEX® 200 aromatic process oil.

In this example, the low temperature s-value and m-value grades of the recovered asphalt binder decreased by −7.7 and −19.1° C., respectively, by blending 90 wt % recovered asphalt binder with 10 wt % RAFFEX® 200 aromatic process oil.

### Example 35

In this example, 80 wt % recovered asphalt binder made using a blend of turpentine liquids according to the present disclosure is blended with 20 wt % RAFFEX® 200 aromatic process oil manufactured by San Joaquin Refining Company, Inc. and described in terms of the performance graded asphalt binder specification.

Before blending with 20 wt % RAFFEX® 200 aromatic process oil, the high temperature grade of the recovered asphalt was determined to be 150.3° C. at 1.0 kPa and 144.8° C. at 2.2 kPa by extrapolating 25 mm DSR data obtained according to AASHTO T 315 at a temperature of 130° C. or slightly lower depending on instrument constraints as described previously. The recovered asphalt binder was determined to have a low temperature s-value grade of −21.9° C. and a low temperature m-value grade of 20.7° C. as measured by BBR according to AASHTO T 313. In this example, the recovered asphalt binder is said to be m-controlled with a performance grade of PG 144.8+20.7.

After blending, the high temperature grade of the formulated recovered asphalt binder and aromatic process oil blend in this example was determined to be 114.5° C. at 1.0 kPa and 104.3° C. at 2.2 kPa by extrapolating 25 mm DSR data obtained according to AASHTO T 315 at a temperature of 130° C. or slightly lower depending on instrument constraints as described previously. The formulated recovered asphalt binder and aromatic process oil blend in this example was determined to have a low temperature s-value grade of −25.2° C. and a low temperature m-value grade of −19.8° C. as measured by BBR according to AASHTO T 313. In this example, the formulated recovered asphalt binder and aromatic process oil blend is said to be m-controlled with a performance grade of PG 104.3-19.8.

In this example, the high temperature grade of the recovered asphalt binder decreased 40.5° C. by blending 80 wt % recovered asphalt binder with 20 wt % RAFFEX® 200 aromatic process oil.

In this example, the low temperature s-value and m-value grades of the recovered asphalt binder decreased by −3.3 and −40.5° C., respectively, by blending 80 wt % recovered asphalt binder with 20 wt % RAFFEX® 200 aromatic process oil.

### Example 36

In this example, manufactured PG 64-22 base asphalt binder is compared to a PG 70-22 modified asphalt binder product made using a combination of the manufactured PG 64-22 base asphalt binder and a precursor recovered asphalt binder made using a blend of turpentine liquids according to the present disclosure. Performance grades of the PG 64-22 base asphalt binder and PG 70-22 modified asphalt binder product were verified according to AASHTO M 320 for comparison.

In one case, 90 wt % PG 64-22 asphalt binder manufactured by the Lion Oil Company was blended with 10 wt % recovered asphalt binder and verified via AASHTO M 320 to have thereby produced an upgraded PG 70-22 modified asphalt binder.

In another case, 90 wt % PG 64-22 asphalt binder manufactured by HollyFrontier Corporation was blended with 10 wt % recovered asphalt binder and verified via AASHTO M 320 to produce an upgraded PG 70-22 modified asphalt binder. Compared to the manufactured PG 64-22 base asphalt binder with elastic recovery of 25% according to ASTM D 6084 Procedure B, the PG 70-22 modified asphalt binder resulted in elastic recovery of 35% according to ASTM D 6084 Procedure B, corresponding to an increase in elastic recovery of 40%.

In another case, 90 wt % PG 64-22 asphalt binder manufactured by NuStar Asphalt LLC (now Axeon Specialty Products LLC) was blended with 10 wt % recovered asphalt binder and verified via AASHTO M 320 to produce an upgraded PG 70-22 modified asphalt binder. Compared to the manufactured PG 64-22 base asphalt binder with elastic recovery of 28% according to ASTM D 6084 Procedure B, the PG 70-22 modified asphalt binder resulted in elastic recovery of 35% according to ASTM D 6084 Procedure B, corresponding to an increase in elastic recovery of 25%.

In another case, 90 wt % PG 64-22 asphalt binder manufactured by NuStar Asphalt LLC was blended with 10 wt % recovered asphalt binder and verified via AASHTO M 320 to produce an upgraded PG 70-22 modified asphalt binder. Compared to the manufactured PG 64-22 base asphalt binder with elastic recovery of 28% according to ASTM D 6084 Procedure B, the PG 70-22 modified asphalt binder resulted in elastic recovery of 38% according to ASTM D 6084 Procedure B, corresponding to an increase in elastic recovery of 36%.

### Example 37

In this example, manufactured PG 64-22 base asphalt binder is compared to a PG 76-22 modified asphalt binder product made using a combination of the manufactured PG 64-22 base asphalt binder in combination with a precursor recovered asphalt binder made using a blend of turpentine liquids according to the present disclosure. Performance grades of the PG 64-22 base asphalt binder and PG 76-22 modified asphalt binder product were verified according to AASHTO M 320 for comparison.

In one case, 80 wt % PG 64-22 asphalt binder manufactured by the NuStar Asphalt LLC was blended with 20 wt % recovered asphalt binder and verified via AASHTO M 320 to produce an upgraded PG 76-22 modified asphalt binder. Compared to the manufactured PG 64-22 base asphalt binder with elastic recovery of 28% according to ASTM D 6084 Procedure B, the PG 76-22 modified asphalt binder resulted in elastic recovery of 40% according to ASTM D 6084 Procedure B, corresponding to an increase in elastic recovery of 43%.

In another case, 80 wt % PG 64-22 asphalt binder manufactured by the NuStar Asphalt LLC was blended with 20 wt % recovered asphalt binder and verified via AASHTO M 320 to produce an upgraded PG 76-22 modified asphalt binder. Compared to the manufactured PG 64-22 base asphalt binder with elastic recovery of 28% according to ASTM D 6084 Procedure B, the PG 76-22 modified asphalt binder resulted in elastic recovery of 42% according to ASTM D 6084 Procedure B, corresponding to an increase in elastic recovery of 50%.

### Example 38

In this example, PG 64-22 base asphalt binder manufactured by NuStar LLC is loaded with a precursor recovered asphalt binder made using a blend of turpentine liquids according to the present disclosure and subsequently graded by 25 mm DSR according to AASHTO T 315 to determine high temperature performance grade and by 4 mm DSR according to a method developed by Western Research Institute to determine low temperature performance grade.

TABLE 10

| | | | High | Low | Low | |
|---|---|---|---|---|---|---|
| | | | Temperature | Temperature s- | Temperature m- | |
| | | Recovered | Grade by 25 mm | value Grade by | value Grade by | |
| | | Asphalt | DSR | 4 mm DSR | 4 mm DSR | |
| | PG 64-22 | Binder | (at 1 kPa) | (at 300 MPa) | (at 0.300) | PG |
| PG Target | wt % | wt % | ° C. | ° C. | ° C. | Grade |
| PG 64-22 | 100 | 0 | 65.7 | −27.1 | −27.2 | PG 65.7-27.1 |
| PG 70-22 | 90 | 10 | 71.1 | −27.7 | −27.4 | PG 71.1-27.4 |
| PG 76-22 | 80 | 20 | 76.6 | −26.3 | −24.9 | PG 76.6-24.9 |

### Example 39

In this example, 84 wt % PG 59.7-30.3 asphalt binder manufactured by Jebro, Inc. was blended with 16 wt % recovered asphalt binder and graded via AASHTO M 320 to have thereby produced an upgraded PG 71.0-28.6 modified asphalt binder. Compared to the manufactured PG 59.7-30.3 base asphalt binder with elastic recovery of 25% according to ASTM D 6084 Procedure A, the PG 71.0-28.6 modified asphalt binder resulted in elastic recovery of 36% according to ASTM D 6084 Procedure A, corresponding to an increase in elastic recovery of 44%. Compared to the manufactured PG 59.7-30.3 base asphalt binder with elastic recovery of 18% according to ASTM D 6084 Procedure B, the PG 71.0-28.6 modified asphalt binder resulted in elastic recovery of 36% according to ASTM D 6084 Procedure B, corresponding to an increase in elastic recovery of 100%.

### Example 40

In this example, 93 wt % PG 66.5-26.0 asphalt binder manufactured by Jebro, Inc. was blended with 7 wt % recovered asphalt binder and graded via AASHTO M 320 to have thereby produced an upgraded PG 71.0-25.4 modified asphalt binder. Compared to the manufactured PG 66.5-26.0 base asphalt binder with elastic recovery of 25% according to ASTM D 6084 Procedure B, the PG 71.0-25.4 modified asphalt binder resulted in elastic recovery of 30% according to ASTM D 6084 Procedure B, corresponding to an increase in elastic recovery of 20%.

### Example 41

In this example, 90 wt % PG 67.7-24.9 asphalt binder manufactured by Valero Marketing and Supply Company was blended with 10 wt % recovered asphalt binder and graded via AASHTO M 320 to have thereby produced an upgraded PG 73.2-22.7 modified asphalt binder. Compared to the manufactured PG 67.7-24.9 base asphalt binder with elastic recovery of 25% according to ASTM D 6084 Procedure B, the PG 73.2-22.7 modified asphalt binder resulted in elastic recovery of 30% according to ASTM D 6084 Procedure B, corresponding to an increase in elastic recovery of 20%.

### Example 42

In this example, 90 wt % PG 66.9-24.0 asphalt binder manufactured by Martin Asphalt Company was blended with 10 wt % recovered asphalt binder and graded via AASHTO M 320 to have thereby produced an upgraded PG 72.2-24.0 modified asphalt binder.

### Example 43

In this example, 97 wt % PG 67.7-24.9 asphalt binder manufactured Valero Marketing and Supply Company was blended with 3 wt % recovered asphalt binder and graded via AASHTO M 320 to have thereby produced an upgraded PG 70.7-22.9 modified asphalt binder.

### Example 44

In this example, 76 wt % PG 59.7-30.3 asphalt binder manufactured by Jebro, Inc. was blended with 24 wt % recovered asphalt binder and graded via AASHTO M 320 to have thereby produced an upgraded PG 77.4-24.7 modified asphalt binder.

### Example 45

In this example, 77 wt % PG 59.7-30.3 asphalt binder manufactured by Jebro, Inc. was blended with 23 wt % recovered asphalt binder and graded via AASHTO M 320 to have thereby produced an upgraded PG 77.1-27.1 modified asphalt binder. Compared to the manufactured PG 59.7-30.3 base asphalt binder with elastic recovery of 25% according to ASTM D 6084 Procedure B, the PG 77.1-27.1 modified asphalt binder resulted in elastic recovery of 30% according to ASTM D 6084 Procedure B, corresponding to an increase in elastic recovery of 20%.

### Example 46

In this example, 84 wt % PG 66.5-26.0 asphalt binder manufactured by Jebro, Inc. was blended with 16 wt % recovered asphalt binder and graded via AASHTO M 320 to have thereby produced an upgraded PG 77.3-20.8 modified asphalt binder. Compared to the manufactured PG 66.5-26.0 base asphalt binder with elastic recovery of 25% according to ASTM D 6084 Procedure B, the PG 77.3-20.8 modified asphalt binder resulted in elastic recovery of 40% according to ASTM D 6084 Procedure B, corresponding to an increase in elastic recovery of 60%.

### Example 47

In this example, 86 wt % PG 66.5-26.0 asphalt binder manufactured by Jebro, Inc. was blended with 14 wt % recovered asphalt binder and graded via AASHTO M 320 to have thereby produced an upgraded PG 76.1-22.0 modified asphalt binder. Compared to the manufactured PG 66.5-26.0 base asphalt binder with elastic recovery of 25% according to ASTM D 6084 Procedure B, the PG 76.1-22.0 modified asphalt binder resulted in elastic recovery of 38% according to ASTM D 6084 Procedure B, corresponding to an increase in elastic recovery of 52%.

### Example 48

In this example, 91 wt % PG 70.3-28.8 asphalt binder manufactured by Jebro, Inc. was blended with 9 wt % recovered asphalt binder and graded via AASHTO M 320 to have thereby produced an upgraded PG 77.0-25.7 modified asphalt binder.

### Example 49

In this example, 91 wt % PG 70.8-26.2 asphalt binder manufactured by Jebro, Inc. was blended with 9 wt % recovered asphalt binder and graded via AASHTO M 320 to have thereby produced an upgraded PG 77.1-23.1 modified asphalt binder.

### Example 50

In this example, manufactured PG 64-22 base asphalt binder is loaded with a precursor recovered asphalt binder made using a blend of turpentine liquids according to the present disclosure and subsequently tested to measure elastic recovery according to ASTM D 6084 Procedure B.

In one case, 100, 90, 88 and 78 wt % PG 64-22 asphalt binders manufactured by HollyFrontier Corporation were blended with 0, 10, 12 and 22 wt % recovered asphalt binder, respectively, resulting in elastic recovery of 25%, 35%, 36% and 45%, respectively, corresponding to an increase in elastic recovery of 0%, 40%, 44% and 80%, respectively.

In another case, 100, 90 and 80 wt % PG 64-22 asphalt binders manufactured by NuStar Asphalt LLC were blended with 0, 10 and 20 wt % recovered asphalt binder, respectively, resulting in elastic recovery of 28%, 35% and 40%, respectively, corresponding to an increase in elastic recovery of 0%, 25% and 43%, respectively.

In another case, 100, 90 and 80 wt % PG 64-22 asphalt binders manufactured by NuStar Asphalt LLC were blended with 0, 10 and 20 wt % recovered asphalt binder, respectively, resulting in elastic recovery of 28%, 38% and 42%, respectively, corresponding to an increase in elastic recovery of 0%, 36% and 50%, respectively.

In one case, 100 and 90 wt % PG 64-22 asphalt binders manufactured by HollyFrontier Corporation were blended with 0 and 10 wt % recovered asphalt binder, respectively, resulting in elastic recovery of 28% and 36%, respectively, corresponding to an increase in elastic recovery of 0% and 36%, respectively.

In another case, 100, 95, 90 and 85 wt % PG 64-22 asphalt binders manufactured by NuStar Asphalt LLC were blended with 0, 5, 10 and 15 wt % recovered asphalt binder, respectively, resulting in elastic recovery of 22%, 29%, 35% and 40%, respectively, corresponding to an increase in elastic recovery of 0%, 32%, 59% and 82%, respectively.

In another case, 100, 84 and 77 wt % PG 59.7-30.3 asphalt binders manufactured by Jebro, Inc. were blended with 0, 16 and 23 wt % recovered asphalt binder, respectively, resulting in elastic recovery of 0%, 100% and 133%, respectively.

In another case, 100, 93, 86, 84 and wt % PG 66.5-26.0 asphalt binders manufactured by Jebro, Inc. were blended with 0, 7, 14 and 16 wt % recovered asphalt binder, respectively, resulting in elastic recovery of 0%, 20%, 52% and 60%, respectively.

In another case, 100 and 90 wt % PG 67.7-24.9 asphalt binders manufactured by Valero Marketing and Supply Company were blended with 0 and 10 wt % recovered asphalt binder, respectively, resulting in elastic recovery of 0% and 20%, respectively.

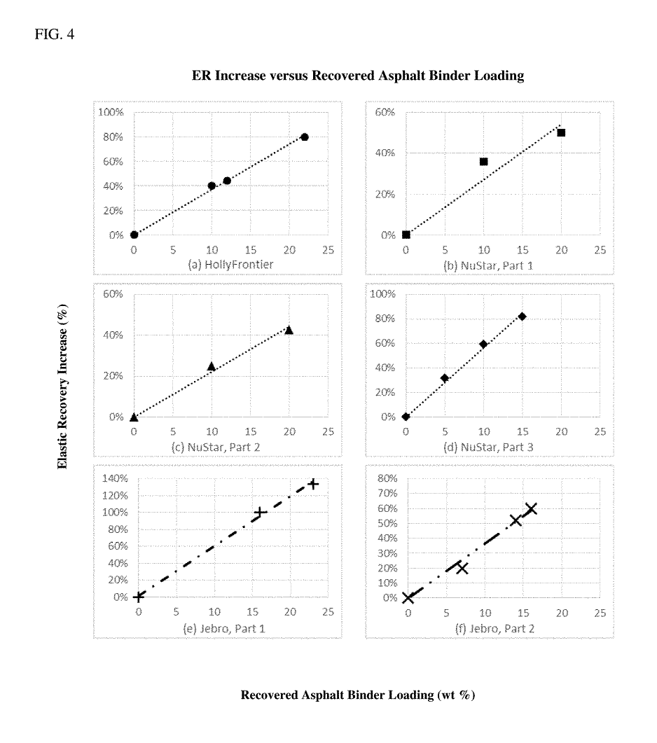

FIG. 4 shows that elastic recovery increases as recovered asphalt binder loading increases.

### Example 51

In this example, a PG 64-22 asphalt binder manufactured by NuStar Asphalt LLC was blended with a predetermined quantity of recovered asphalt binder made using a turpentine liquid according to the present disclosure to establish failing AASHTO M 320 baseline blends at PG 76-22. Each baseline blend was subsequently modified with Kraton D1192 styrene-butadiene-styrene (SBS) until a DSR value of 1.3 kPa±0.5 kPa at 76° C. was achieved according to AASHTO T 315 before verifying PG 76-22 modified asphalt binder grade according to AASHTO M 320.

TABLE 7

| Baseline Blends | | PG 76-22 Modified Blends | | | |
|---|---|---|---|---|---|
| | Recovered | | Recovered | | |
| | Asphalt | | Asphalt | | |
| PG 64-22 | Binder | PG 64-22 | Binder | SBS | Total |
| wt % | wt % | wt % | wt % | wt % | wt % |
| 100 | 0 | 96.39 | 0.00 | 3.61 | 100 |
| 95 | 5 | 91.65 | 4.82 | 3.52 | 100 |
| 90 | 10 | 87.98 | 9.78 | 2.25 | 100 |
| 85 | 15 | 83.70 | 14.77 | 1.53 | 100 |

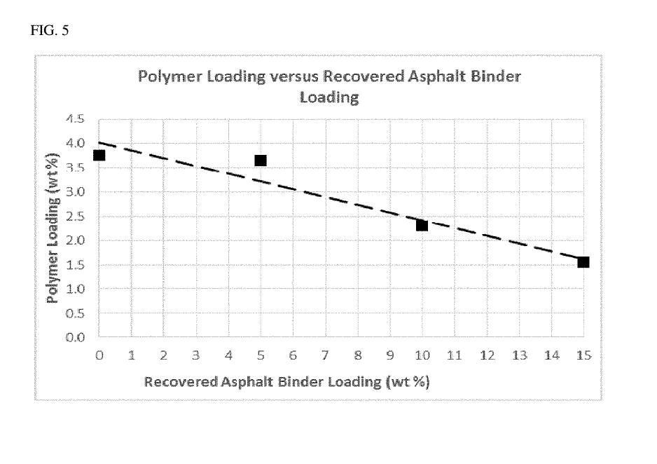

FIG. 5 shows that polymer loading decreases as recovered asphalt binder loading increases, which decreases total cost to produce performance-enhanced PG 76-22 modified asphalt binders.

### Example 52

In this example, a PG 64-22 asphalt binder manufactured by NuStar Asphalt LLC was blended with a predetermined quantity of recovered asphalt binder made using a turpentine liquid of terpineol, pinene and cymene according to the present invention to establish failing AASHTO M 320 baseline blends at PG 76-22. Each baseline blend was subsequently modified with Edge CRX-3b crumb rubber (CR) until a DSR value of 1.3 kPa±0.5 kPa at 76° C. was achieved according to AASHTO T 315 before verifying PG 76-22 modified asphalt binder grade according to AASHTO M 320.

TABLE 8

| Baseline Blends | | PG 76-22 Modified Blends | | | |
|---|---|---|---|---|---|
| | Recovered | | Recovered | | |
| | Asphalt | | Asphalt | | |
| PG 64-22 | Binder | PG 64-22 | Binder | CR | Total |
| wt % | wt % | wt % | wt % | wt % | wt % |
| 100 | 0 | 91.74 | 0.00 | 8.26 | 100 |
| 95 | 5 | 88.37 | 4.65 | 6.98 | 100 |
| 90 | 10 | 85.84 | 9.54 | 4.63 | 100 |
| 85 | 15 | 83.33 | 14.71 | 1.96 | 100 |

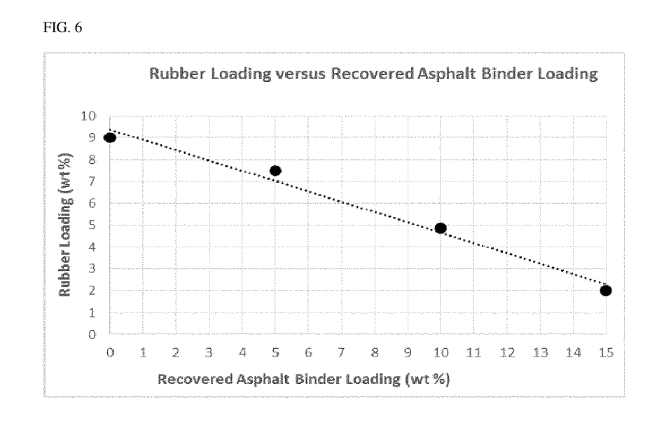

FIG. 6 shows that rubber loading decreases as recovered asphalt binder loading increases, which reduces the amount of polymer required and total cost to produce performance-enhanced PG 76-22 modified asphalt binders.

### Example 53

In this example, a PG 64-22 asphalt binder manufactured by NuStar Asphalt LLC was blended with a predetermined quantity of recovered asphalt binder made using a turpentine liquid according to the present disclosure to establish failing AASHTO M 320 baseline blends at PG 76-22. Each baseline blend was subsequently modified with Edge CRX-3b crumb rubber (CR-T) that was treated until a DSR value of 1.3 kPa±0.5 kPa at 76° C. was achieved according to AASHTO T 315 before verifying PG 76-22 modified asphalt binder grade according to AASHTO M 320.

TABLE 9

| Baseline Blends | | PG 76-22 Modified Blends | | | |
|---|---|---|---|---|---|
| | Recovered | | Recovered | | |
| | Asphalt | | Asphalt | | |
| PG 64-22 | Binder | PG 64-22 | Binder | CR-T | Total |
| wt % | wt % | wt % | wt % | wt % | wt % |
| 100 | 0 | 92.17 | 0.00 | 7.83 | 100 |
| 95 | 5 | 89.45 | 4.71 | 5.84 | 100 |
| 90 | 10 | 86.54 | 9.62 | 3.85 | 100 |
| 85 | 15 | 83.33 | 14.71 | 1.96 | 100 |

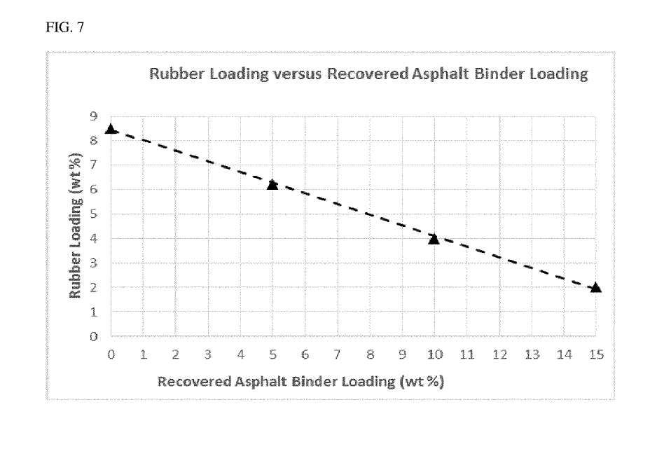

FIG. 7 shows that rubber loading decreases as recovered asphalt binder loading increases, which reduces the amount of polymer required and total cost to produce performance-enhanced PG 76-22 modified asphalt binders.

### Example 54

In this example, manufactured PG 76-22 polymer modified asphalt binder comprised of manufactured PG 64-22 base asphalt binder and styrene-butadiene-styrene (SBS) polymer is compared to a modified asphalt binder product made using a combination of the aforementioned manufactured PG 76-22 polymer modified asphalt binder, the aforementioned manufactured PG 64-22 base asphalt binder and a precursor recovered asphalt binder made using a blend of turpentine liquids according to the present disclosure. Performance grades of the manufactured PG 64-22 base asphalt binder, the manufactured PG 76-22 polymer modified asphalt binder and the modified asphalt binder product were determined according to AASHTO M 320.

In one case, a manufactured PG 80.7-24.4 polymer modified asphalt binder is comprised of manufactured PG 67.9-25.6 base asphalt binder and SBS polymer. 62.5 wt % manufactured PG 80.7-24.4 polymer modified asphalt binder is back-blended with 34.5 wt % manufactured PG 67.9-25.6 base asphalt binder and 3 wt % recovered asphalt binder and graded via AASHTO M 320 to produce a PG 77.5-23.8 modified asphalt binder. Compared to the manufactured PG 80.7-24.4 polymer modified asphalt binder, the PG 77.5-23.8 modified asphalt binder resulted in a reduction of polymer quantity of 38%. Compared to the manufactured PG 80.7-24.4 polymer modified asphalt binder with elastic recovery of 63% according to ASTM D 6084 Procedure A, the PG 77.5-23.8 modified asphalt binder resulted in elastic recovery of 55% according to ASTM D 6084 Procedure A. Compared to the manufactured PG 80.7-24.4 polymer modified asphalt binder with elastic recovery of 80% according to ASTM D 6084 Procedure B, the PG 77.5-23.8 modified asphalt binder resulted in elastic recovery of 70% according to ASTM D 6084 Procedure B. Compared to the manufactured PG 80.7-24.4 polymer modified asphalt binder and the manufactured PG 67.9-25.6 base asphalt binder with solubility of 99.99% and 99.99%, respectively, according to ASTM D 2042, the PG 77.5-23.8 modified asphalt binder resulted in solubility of 99.94% according to ASTMD 2042.

In another case, a manufactured PG 80.7-24.4 polymer modified asphalt binder is comprised of manufactured PG 67.9-25.6 base asphalt binder and SBS polymer. 31.25 wt % manufactured PG 80.7-24.4 polymer modified asphalt binder is back-blended with 59.75 wt % manufactured PG 67.9-25.6 base asphalt binder and 9 wt % recovered asphalt binder and graded via AASHTO M 320 to produce a PG 76.9-23.1 modified asphalt binder. Compared to the manufactured PG 80.7-24.4 polymer modified asphalt binder, the PG 76.9-23.1 modified asphalt binder resulted in a reduction of polymer quantity of 69%. Compared to the manufactured PG 80.7-24.4 polymer modified asphalt binder with elastic recovery of 63% according to ASTM D 6084 Procedure A, the PG 76.9-23.1 modified asphalt binder resulted in elastic recovery of 45% according to ASTM D 6084 Procedure A. Compared to the manufactured PG 80.7-24.4 polymer modified asphalt binder with elastic recovery of 80% according to ASTM D 6084 Procedure B, the PG 76.9-23.1 modified asphalt binder resulted in elastic recovery of 55% according to ASTM D 6084 Procedure B. Compared to the manufactured PG 80.7-24.4 polymer modified asphalt binder and the manufactured PG 76.9-23.1 base asphalt binder with solubility of 99.99% and 99.99%, respectively, according to ASTM D 2042, the PG 77.5-23.8 modified asphalt binder resulted in solubility of 99.95% according to ASTMD 2042.

### Example 55

In this example, manufactured PG 76-28 polymer modified asphalt binder comprised of manufactured PG 52-28 base asphalt binder and styrene-butadiene-styrene (SBS) polymer is compared to a modified asphalt binder product made using a combination of the aforementioned manufactured PG 76-28 polymer modified asphalt binder, the aforementioned manufactured PG 52-28 base asphalt binder and a precursor recovered asphalt binder made using a blend of turpentine liquids according to the present disclosure. Performance grades of the manufactured PG 52-28 base asphalt binder, the manufactured PG 76-28 polymer modified asphalt binder and the modified asphalt binder product were determined according to AASHTO M 320.

In one case, a manufactured PG 78.8-39.1 polymer modified asphalt binder is comprised of manufactured PG 56.4-30.9 base asphalt binder and SBS polymer. 71.43 wt % manufactured PG 78.8-39.1 polymer modified asphalt binder is back-blended with 13.57 wt % manufactured PG 56.4-30.9 base asphalt binder and 15 wt % recovered asphalt binder and graded via AASHTO M 320 to produce a PG 77.6-28.0 modified asphalt binder. Compared to the manufactured PG 78.8-39.1 polymer modified asphalt binder, the PG 77.6-28.0 modified asphalt binder resulted in a reduction of polymer quantity of 29%. Compared to the manufactured PG 78.8-39.1 polymer modified asphalt binder with elastic recovery of 84% according to ASTM D 6084 Procedure A, the PG 77.6-28.0 modified asphalt binder resulted in elastic recovery of 72% according to ASTM D 6084 Procedure A. Compared to the manufactured PG 78.8-39.1 polymer modified asphalt binder with elastic recovery of 94% according to ASTM D 6084 Procedure B, the PG 77.6-28.0 modified asphalt binder resulted in elastic recovery of 85% according to ASTM D 6084 Procedure B. Compared to the manufactured PG 78.8-39.1 polymer modified asphalt binder with percent recovery at 3.2 kPa of 94.79% according to AASHTO T 350, the PG 77.6-28.0 modified asphalt binder resulted in percent recovery at 3.2 kPa of 87.84% according to AASHTO T 350. Compared to the manufactured PG 78.8-39.1 polymer modified asphalt binder and the manufactured PG 56.4-30.9 base asphalt binder with solubility of 99.84% and 99.94%, respectively, according to ASTM D 2042, the PG 77.6-28.0 modified asphalt binder resulted in solubility of 99.89% according to ASTMD 2042.

In one case, a manufactured PG 78.8-39.1 polymer modified asphalt binder is comprised of manufactured PG 56.4-30.9 base asphalt binder and SBS polymer. 42.86 wt % manufactured PG 78.8-39.1 polymer modified asphalt binder is back-blended with 40.14 wt % manufactured PG 56.4-30.9 base asphalt binder and 17 wt % recovered asphalt binder and graded via AASHTO M 320 to produce a PG 77.6-23.1 modified asphalt binder. Compared to the manufactured PG 78.8-39.1 polymer modified asphalt binder, the PG 77.6-23.1 modified asphalt binder resulted in a reduction of polymer quantity of 57%. Compared to the manufactured PG 78.8-39.1 polymer modified asphalt binder with elastic recovery of 84% according to ASTM D 6084 Procedure A, the PG 77.6-23.1 modified asphalt binder resulted in elastic recovery of 58% according to ASTM D 6084 Procedure A. Compared to the manufactured PG 78.8-39.1 polymer modified asphalt binder with elastic recovery of 94% according to ASTM D 6084 Procedure B, the PG 77.6-23.1 modified asphalt binder resulted in elastic recovery of 72% according to ASTM D 6084 Procedure B. Compared to the manufactured PG 78.8-39.1 polymer modified asphalt binder with percent recovery at 3.2 kPa of 94.79% according to AASHTO T 350, the PG 77.6-23.1 modified asphalt binder resulted in percent recovery at 3.2 kPa of 72.12% according to AASHTO T 350. Compared to the manufactured PG 78.8-39.1 polymer modified asphalt binder and the manufactured PG 56.4-30.9 base asphalt binder with solubility of 99.84% and 99.94%, respectively, according to ASTM D 2042, the PG 77.6-28.0 modified asphalt binder resulted in solubility of 99.98% according to ASTMD 2042.

### Example 56

In this example, manufactured PG 76-22 polymer modified asphalt binder comprised of manufactured PG 64-22 base asphalt binder and styrene-butadiene-styrene (SBS) polymer is compared to a modified asphalt binder product made using a combination of the aforementioned manufactured PG 76-22 polymer modified asphalt binder, the aforementioned manufactured PG 64-22 base asphalt binder and a precursor recovered asphalt binder made using a blend of turpentine liquids according to the present disclosure. Performance grades of the manufactured PG 64-22 base asphalt binder, the manufactured PG 76-22 polymer modified asphalt binder and the modified asphalt binder product were determined according to AASHTO M 320.

In one case, a manufactured PG 77.0-22.4 polymer modified asphalt binder is comprised of manufactured PG 66.9-24.0 base asphalt binder and SBS polymer. 62.5 wt % manufactured PG 77.0-22.4 polymer modified asphalt binder is back-blended with 27.5 wt % manufactured 66.9-24.0 base asphalt binder and 10 wt % recovered asphalt binder and graded via AASHTO M 320 to produce a PG 77.0-20.5 modified asphalt binder. Compared to the manufactured PG 77.0-22.4 polymer modified asphalt binder, the PG 77.0-20.5 modified asphalt binder resulted in a reduction of polymer quantity of 38%. Compared to the manufactured PG 77.0-22.4 polymer modified asphalt binder with elastic recovery of 71% according to ASTM D 6084 Procedure A, the PG 77.0-20.5 modified asphalt binder resulted in elastic recovery of 60% according to ASTM D 6084 Procedure A. Compared to the manufactured PG 77.0-22.4 polymer modified asphalt binder with elastic recovery of 78% according to ASTM D 6084 Procedure B, the PG 77.5-20.5 modified asphalt binder resulted in elastic recovery of 69% according to ASTM D 6084 Procedure B. Compared to the manufactured PG 77.0-22.4 polymer modified asphalt binder with solubility of 99.91% according to ASTM D 2042, the PG 77.0-20.5 modified asphalt binder resulted in solubility of 99.99% according to ASTMD 2042.

In another case, a manufactured PG 77.0-22.4 polymer modified asphalt binder is comprised of manufactured PG 66.9-24.0 base asphalt binder and SBS polymer. 31.25 wt % manufactured PG 77.0-22.4 polymer modified asphalt binder is back-blended with 57.75 wt % manufactured 66.9-24.0 base asphalt binder and 11 wt % recovered asphalt binder and graded via AASHTO M 320 to produce a PG 76.8-20.5 modified asphalt binder. Compared to the manufactured PG 77.0-22.4 polymer modified asphalt binder, the PG 76.8-20.5 modified asphalt binder resulted in a reduction of polymer quantity of 69%. Compared to the manufactured PG 77.0-22.4 polymer modified asphalt binder with elastic recovery of 71% according to ASTM D 6084 Procedure A, the PG 76.8-20.5 modified asphalt binder resulted in elastic recovery of 49% according to ASTM D 6084 Procedure A. Compared to the manufactured PG 77.0-22.4 polymer modified asphalt binder with elastic recovery of 78% according to ASTM D 6084 Procedure B, the PG 76.8-20.5 modified asphalt binder resulted in elastic recovery of 56% according to ASTM D 6084 Procedure B. Compared to the manufactured PG 77.0-22.4 polymer modified asphalt binder with solubility of 99.91% according to ASTM D 2042, the PG 76.8-20.5 modified asphalt binder resulted in solubility of 99.98% according to ASTMD 2042.

### Example 57

Exemplary formulations that are used to obtain a recovered asphalt binder include, but are not limited to the following:

One of the following:

100% alpha-terpineol; 100% alpha-pinene; 100% beta-pinene; 100% para-cymene; or 100% pine oil;

30-70% α-terpineol, 5-40% β-pinene, 5-50% α-pinene, and 0-30% p-cymene;

40-60% α-terpineol, 10-20% α-pinene, 10-40% β-pinene, and 5-20% p-cymene;

45-55% α-terpineol, 30-40% α-pinene, 5-30% β-pinene, and 10-30% p-cymene;

50% α-terpineol, 25% α-pinene, 20% β-pinene, and 5% p-cymene;

30-70% pine oil, 30-70% α-terpineol, 5-40% β-pinene, 5-50% α-pinene, and 0-30% p-cymene;

15-25% α-terpineol, 10-15% α-pinene, 10-15% β-pinene, and 45-65% p-cymene;

10-20% α-terpineol, 5-10% α-pinene, 5-10% β-pinene, and 40-80% p-cymene;

5-35% α-terpineol, 5-15% α-pinene, 5-15% β-pinene, and 35-85% p-cymene;

30-50% pine oil, 40-60% α-terpineol, 10-20% α-pinene, 10-40% β-pinene, and 5-20% p-cymene;

30-40% pine oil, 45-55% α-terpineol, 30-40% α-pinene, 5-30% β-pinene, and 10-30% p-cymene.

In further examples, any one of the exemplary formulations of Example 13 is mixed/diluted with 0.5% to 49.5% of a non-turpentine aromatic fluid, paraffinic fluid or combination thereof with respect to the weight of the total mixed formulation.

In summary, recovered asphalt binder utilized as precursor material according to the present disclosure is virtually particle-free, is highly soluble in asphalt binder, improves asphalt binder performance, increases asphalt binder elasticity, has high stiffness and elasticity, improves modified asphalt binder product low temperature grade and/or high temperature grade, provides substantial cost savings compared to commercial modifiers, additives and polymers, and has significant environmental benefits.

As used herein, the terms about and approximately should be interpreted to include any values which are within 5% of the recited value. Furthermore, recitation of the term about and approximately with respect to a range of values should be interpreted to include both the upper and lower end of the recited range. As used herein, the terms first, second, third and the like should be interpreted to uniquely identify elements and do not imply or restrict to any particular sequencing of elements or steps.

Concentrations, amounts, and other numerical data may be presented here in a range format (e.g., from about 5% to about 20%). It is to be understood that such range format is used merely for convenience and brevity, and should be interpreted flexibly to include not only the numerical values explicitly recited as the limits of the range, but also to include all the individual numerical values or sub-ranges encompassed within that range, as if each numerical value and sub-range is explicitly recited unless otherwise indicated. For example, a range of from about 5% to about 20% should be interpreted to include numerical values such as, but not limited to 5%, 5.5%, 9.7%, 10.3%, 15%, etc., and sub-ranges such as, but not limited to 5% to 10%, 10% to 15%, 8.9% to 18.9%, etc.

While the invention has been shown or described in only some of its embodiments, it should be apparent to those skilled in the art that it is not so limited, but is susceptible to various changes without departing from the spirit and scope of the invention. Furthermore, it is to be understood that the form of the invention shown and described is to be taken as presently preferred embodiments. Various modifications and changes may be made to each and every processing step as would be obvious to a person skilled in the art having the benefit of this disclosure. It is intended that the following claims be interpreted to embrace all such modifications and changes and, accordingly, the specification is to be regarded in an illustrative rather than a restrictive sense. Moreover, it is intended that the appended claims be construed to include alternative embodiments.

1. A method of making a recovered asphalt binder comprising:
a) contacting an asphalt-containing material with an asphalt-dissolving liquid to form a reaction mixture containing liquid asphalt dissolved into said asphalt-dissolving fluid and undissolved solids;
b) performing a solid-liquid separation of the reaction mixture to produce a solid portion containing bulk solids and a liquid portion containing liquid asphalt dissolved into an asphalt-dissolving fluid and particulate matter;
c) performing liquid-solid separation of the liquid portion to produce a particulate solids portion and a particulate-removed liquid portion of liquid asphalt dissolved into the asphalt-dissolving fluid; and
d) distilling the particulate-removed liquid portion to produce a distilled asphalt-dissolving fluid portion and a recovered asphalt binder portion.

2. The method of claim 1, wherein said particulate-removed liquid portion has particulate matter content less than 1 wt. % particulate matter.

3. The method of claim 1, wherein the contacting occurs at a temperature in the range of about 30° C. to about 100° C.

4. The method of claim 1, wherein the asphalt-containing material is a naturally occurring asphalt-containing material.

5. The method of claim 1, wherein the asphalt-containing material is any asphalt-based manufactured product used for roofing applications or paving applications.

6. The method of claim 1, wherein the asphalt-dissolving liquid comprises natural turpentine, synthetic turpentine, pine oil, crude stump turpentine, crude wood oil, d-limonene, α-pinene, β-pinene, α-terpineol, β-terpineol, γ-terpineol, 3-carene, anethole, dipentene (p-mentha-1,8-diene), terpene resins, nopol, pinane, camphene, p-cymene, anisaldehyde, 2-pinane hydroperoxide, 3,7-dimethyl-1,6-octadiene, isobornyl acetate, terpin hydrate, ocimene, 2-pinanol, dihydromyrcenol, isoborneol, α-terpineol, alloocimene, alloocimene alcohols, geraniol, 2-methoxy-2,6-dimethyl-7,8-epoxyoctane, camphor, p-menthan-8-ol, α-terpinyl acetate, citral, citronellol, 7-methoxydihydrocitronellal, 10-camphorsulphonic acid, p-menthene, p-menthan-8-yl acetate, citronellal,7-hydroxydihydrocitronellal, menthol, menthone, a polymer thereof, or a mixture thereof.

7. The method of claim 6, wherein the asphalt-dissolving liquid comprises α-pinene, β-pinene, α-terpineol, p-cymene, a polymer thereof, or a mixture thereof.

8. The method of claim 6, wherein the asphalt-dissolving liquid comprises a mixture of: 30-70% α-terpineol, 5-40% β-pinene, 5-50% α-pinene, and 0-30% p-cymene; 40-60% α-terpineol, 10-20% α-pinene, 10-40% β-pinene, and 5-20% p-cymene; 45-55% α-terpineol, 30-40% α-pinene, 5-30% β-pinene, and 10-30% p-cymene; 50% α-terpineol, 25% α-pinene, 20% β-pinene, and 5% p-cymene; 30-70% pine oil, 30-70% α-terpineol, 5-40% β-pinene, 5-50% α-pinene, and 0-30% p-cymene; 15-25% α-terpineol, 10-15% α-pinene, 10-15% β-pinene, and 45-65% p-cymene; 10-20% α-terpineol, 5-10% α-pinene, 5-10% β-pinene, and 40-80% p-cymene; 5-35% α-terpineol, 5-15% α-pinene, 5-15% β-pinene, and 35-85% p-cymene 30-50% pine oil, 40-60% α-terpineol, 10-20% α-pinene, 10-40% β-pinene, and 5-20% p-cymene; or 30-40% pine oil, 45-55% α-terpineol, 30-40% α-pinene, 5-30% 62 -pinene, and 10-30% p-cymene.

9. The method of claim 1, wherein the recovered asphalt binder has less than 1.0 wt. % particulate matter.

10. The method of claim 1, wherein the recovered asphalt binder has solubility in trichloroethylene according to ASTM D 2042 greater than about 99%.

11. The method of claim 1, wherein the recovered asphalt binder has a penetration value of from about 0 to about 100 1/10 mm.

12. The method of claim 1, wherein the recovered asphalt binder has a penetration value of from about 1 to about 10 1/10 mm.

13. The method of claim 1, wherein the recovered asphalt binder has a softening point of about 20° C. to about 200° C.

14. The method of claim 13, wherein the recovered asphalt binder has a softening point of about 55° C. to about 110° C.

15. The method of claim 13, wherein the recovered asphalt binder has a softening point of about 110° C. to about 155° C.

16. The method of claim 1, wherein the recovered asphalt binder has high temperature grade of about 30° C. to about 200° C.

17. The method of claim 16, wherein the recovered asphalt binder has high temperature grade of about 130° C. to about 190° C.

18. The method of claim 1, wherein the recovered asphalt binder has low temperature stiffness grade (s-value) of about 20° C. to about −60° C. and/or a low temperature m-value of about 20° C. to about −60° C.

19. The method of claim 6, wherein the asphalt-dissolving liquid contains between 0.5% and 49.5% of a non-turpentine aromatic fluid, paraffinic fluid or combination thereof.

20. The method of claim 19, wherein the non-turpentine aromatic fluid contains aromatic components having a carbon number of C₅ to C₂₀, a boiling point from about 100° C. to about 400° C. and a density of about 0.8 g/mL to about 1.0 g/mL at 15.6° C.

21. The method of claim 19, wherein the non-turpentine paraffinic fluid contains paraffinic components having a carbon number of C₅ to C₂₀, a boiling point from about 50° C. to about 400° C. and a density of about 0.6 g/mL to about 0.9 g/mL at 15.6° C.

22. The method of claim 6, wherein the asphalt-dissolving liquid does not contain a non-turpentine paraffinic fluid and/or does not contain a non-turpentine paraffinic fluid.

23. The method of claim 1, wherein the contacting comprises contacting the asphalt-dissolving liquid with the asphalt-containing material in a mass ratio of about 0.5:1 to about 20:1.

24. The method of claim 1, wherein the contacting comprises contacting the asphalt-dissolving liquid with the asphalt-containing material in a mass ratio of about 3:1 to about 10:1.

25. The method of claim 1, wherein the contacting comprises contacting the asphalt-dissolving liquid with the asphalt-containing material in a mass ratio of about 4:1 to about 7:1.

26. The method of claim 1, further comprising contacting the bulk solids and/or the particulate solids portion with the asphalt-dissolving fluid to form a secondary reaction mixture containing liquid asphalt dissolved into the asphalt-dissolving fluid and non-dissolved solids, performing a solid-liquid separation of the secondary reaction mixture to produce a portion of bulk solids and a secondary liquid portion of liquid asphalt dissolved into an asphalt-dis solving fluid and particulate matter, performing a liquid-solid separation of the secondary liquid portion to produce a secondary particulate solids portion and a secondary particulate-removed liquid portion of liquid asphalt dissolved into an asphalt-dissolving fluid, subjecting the particulate-removed secondary liquid portion to distillation to produce distilled asphalt-dissolving fluid portion and a recovered asphalt binder portion.

27. The method of claim 1, wherein step b) comprises gravity settling, filtration using filter media with a nominal pore size from about 0.4 microns to about 50 microns, multistage filtration using filter media with a nominal pore size from about 0.4 microns to about 50 microns, centrifugation with a gravitational force from about 300 to about 10,000 for about 1 minute to about 30 minutes, or a combination thereof.

28. The method of claim 1, further comprising cooling the recovered asphalt binder following distillation to a temperature of about 25° C. or less to solidify the recovered asphalt binder.

29. The method of claim 1, further comprising preheating a liquid asphalt material to be modified with the recovered asphalt binder, adding the recovered asphalt binder to the liquid asphalt material that has been preheated until a target mass ratio between the liquid asphalt material and the recovered asphalt binder is achieved, mixing and heating for at least about 15 minutes to obtain a modified asphalt binder product.

30. The method of claim 29, wherein said recovered asphalt binder is added in solid form to said liquid asphalt material that has been preheated.

31. The method of claim 29, wherein the preheating is to a temperature of about 135° C. to about 185° C. and/or the mixing is at a temperature of about 135° C. to about 185° C.

32. The method of claim 29, wherein the ratio is about 65-95 wt. % liquid asphalt material to be modified with about 5-35 wt. % of the recovered asphalt binder.

33. A modified asphalt binder product comprising about 5-35 wt. % of a recovered asphalt binder and about 65-95 wt. % liquid asphalt material having a performance grade (PG) and a useful temperature interval (UTI), wherein at least one of PG and elastic recovery is higher in the modified asphalt binder product compared to the liquid asphalt material, or at least one of polymer modifier amount needed to meet a PG requirement, rubber modifier amount needed to meet a PG requirement, and filler additive amount needed to meet a PG requirement is lower in the modified asphalt binder product compared to the liquid asphalt material.

34. The modified asphalt binder product of claim 33, wherein PG and elastic recovery are improved in the modified asphalt binder product, compared to PG of the liquid asphalt material.

35. The modified asphalt binder product of claim 33, wherein PG is improved and/or elastic recovery is higher and the polymer modifier amount needed to meet a PG requirement is lower in the modified asphalt binder product, compared to the PG and polymer modifier amount needed to meet a PG requirement of the liquid asphalt material.

36. The modified asphalt binder product of claim 33, wherein PG is improved and/or elastic recovery is higher and the rubber modifier amount needed to meet a PG requirement is lower in the modified asphalt binder product, compared to the PG and rubber modifier amount needed to meet a PG requirement of the liquid asphalt material.

37. The modified asphalt binder product of claim 33, wherein PG is improved and/or elastic recovery is higher and the filler additive amount needed to meet a PG requirement is lower in the modified asphalt binder product, compared to the PG and filler additive amount needed to meet a PG requirement of the liquid asphalt material.

38. The modified asphalt binder product of claim 33, wherein the modified asphalt binder product has at least a one grade improved high temperature PG than the PG of the liquid asphalt material.

39. The modified asphalt binder product of claim 33, wherein the high temperature PG of the liquid asphalt material is improved by 6-30° C. in the modified asphalt binder product than the PG of the liquid asphalt material.

40. The modified asphalt binder product of claim 33, wherein the modified asphalt binder product has at least a one grade improved low temperature PG than the PG of the liquid asphalt material.

41. The modified asphalt binder product of claim 38, wherein a low temperature stiffness s-value of the liquid asphalt material is improved by 6-18° C. in the modified asphalt binder product that has at least a one grade improved high temperature PG than the PG of the liquid asphalt material.

42. The modified asphalt binder product of claim 38, wherein a low temperature m-value of the liquid asphalt material is not degraded in the modified asphalt binder product that has at least a one grade improved high temperature PG than the PG of the liquid asphalt material.

43. The modified asphalt binder product of claim 33, wherein the elastic recovery is 15-150% higher in the modified asphalt binder product compared to the elastic recovery of the liquid asphalt material.

44. The modified asphalt binder product of claim 33, wherein the modified asphalt binder product has a 6-204 degrees higher UTI than the UTI of the liquid asphalt material.

45. A method of producing a modified asphalt binder product comprising:
a) preheating a liquid asphalt material having a performance grade (PG),
b) adding a recovered asphalt binder to the liquid asphalt material that has been preheated until a target mass ratio between the liquid asphalt material and the recovered asphalt binder is achieved, and
c) mixing and heating for at least about 15 minutes to obtain a modified asphalt binder product, wherein at least one of PG and elastic recovery is higher in the modified asphalt binder product compared to the liquid asphalt material, or wherein at least one of polymer modifier amount needed to meet a PG requirement, rubber modifier amount needed to meet a PG requirement, and filler additive amount needed to meet a PG requirement is lower in the modified asphalt binder product compared to the liquid asphalt material.

46. The method of claim 45, wherein the recovered asphalt binder has particulate matter content less than 1 wt. % particulate matter.

47. The method of claim 45, wherein the recovered asphalt binder has solubility in trichloroethylene according to ASTM D 2042 greater than about 99%.

48. The method of claim 45, wherein the recovered asphalt binder has a penetration value of from about 1 to about 100 1/10 mm.

49. The method of claim 45, wherein the recovered asphalt binder has a softening point of about 20° C. to about 200° C.

50. The method of claim 45, wherein the recovered asphalt binder has a softening point of about 55° C. to about 110° C.

51. The method of claim 45, wherein the recovered asphalt binder has a softening point of about 110° C. to about 155° C.

52. The method of claim 45, wherein the recovered asphalt binder has high temperature grade of about 30° C. to about 200° C.

53. The method of claim 45, wherein the preheating and/or the mixing is to a temperature of about 135° C. to about 185° C.

54. The method of claim 45, wherein elastic recovery is higher and the polymer modifier amount and/or the rubber amount needed to meet a PG requirement is lower in the modified asphalt binder product, compared to the elastic recovery and polymer modifier amount needed to meet a PG requirement of the liquid asphalt material.

55. The method of claim 45, wherein PG is improved and the rubber modifier amount and/or the filler additive amount needed to meet a PG requirement is lower in the modified asphalt binder product, compared to the PG and rubber modifier amount needed to meet a PG requirement of the liquid asphalt material.

56. The method of claim 45, wherein elastic recovery is higher and the filler additive amount needed to meet a PG requirement is lower in the modified asphalt binder product, compared to the elastic recovery and filler additive amount needed to meet a PG requirement of the liquid asphalt material.

57. The method of claim 45, wherein the modified asphalt binder product has at least a one grade higher high temperature PG than the PG of the liquid asphalt material.

58. A recovered asphalt binder comprising a distilled liquid asphalt, wherein the recovered asphalt binder has less than 1.0 wt.% particulate matter, solubility in trichloroethylene according to ASTM D 2042 greater than about 99%, a penetration value of from about 0 to about 300 1/10 mm, a softening point of about 20° C. to about 200° C., a high temperature grade of about 30° C. to about 200° C., a low temperature stiffness grade (s-value) of about 20° C. to about −60° C., and a low temperature m-value of about 20° C. to about −60° C.
